(19) United States
(12) Patent Application Publication
(10) Pub. No.: US 2021/0398083 A1
(43) Pub. Date: Dec. 23, 2021

(54) INFORMATION PROVIDING DEVICE, INFORMATION PROVIDING SYSTEM, INFORMATION PROVIDING METHOD, AND NON-TRANSITORY COMPUTER-READABLE MEDIUM STORING PROGRAM

(71) Applicant: NEC Corporation, Minato-ku, Tokyo (JP)

(72) Inventors: Kan ARAI, Tokyo (JP); Daisuke TOKUSHIMA, Tokyo (JP); Yoshinori SAIDA, Tokyo (JP)

(73) Assignee: NEC Corporation, Minato-ku, Tokyo (JP)

(21) Appl. No.: 17/421,354

(22) PCT Filed: Nov. 1, 2019
(86) PCT No.: PCT/JP2019/042985

§ 371 Date: Jul. 7, 2021

(30) Foreign Application Priority Data
Jan. 17, 2019 (JP) 2019-006043

(51) Int. Cl. G06Q 10/10; G06Q 10/06

(52) U.S. Cl. CPC G06Q 10/1053; G06Q 10/063112

(57) ABSTRACT

An information providing device being capable of objectively evaluating a career of a user is provided. A job history acquisition unit (11) acquires job history information indicating a job history of a user. A similarity degree calculation unit (12) calculates a similarity degree between the job history information and each of a plurality of pieces of job offer information. A job offer information extraction unit (13) extracts the job offer information of which the similarity degree is equal to or more than a predetermined criterion. A proper job level calculation unit (14) calculates a proper job level of the user by use of the extracted job offer information. A proper job level display unit (15) performs processing for displaying the calculated proper job level.

### TECHNICAL FIELD

The present invention relates to an information providing device, an information providing system, an information providing method, and a non-transitory computer-readable medium storing a program, and particularly relates to an information providing device, an information providing system, an information providing method, and a non-transitory computer-readable medium storing a program, which provide information relating to a job of a user.

### BACKGROUND ART

For example, a human resource introduction company or the like performs matching between job offer information (a job offer advertisement or the like) prepared by a job offer side such as an enterprise and job history information prepared by a job seeking side, and provides the job seeking side with information about an enterprise satisfying a condition. In connection with this technique, Patent Literature 1 discloses a job finding/job transfer support system that can easily determine an enterprise is an enterprise suited to a person in a job finding/job transfer activity. In the system according to Patent Literature 1, associated (i.e., corresponding) job offer information is displayed on a job-seeking-side terminal in a highlighted way in descending order of a satisfaction degree of both pieces of information. Patent Literature 2 discloses a similarity learning system utilized during matching between job offer information and resume information of a job seeking side. The similarity learning system according to Patent Literature 2 performs similarity degree learning between job offer information and resume information of a job seeking side by utilizing an analysis method by a topic model, and calculates a similarity degree between the job offer information and the resume information of the job seeking side by use of similarity degree learning information representing a learning result of the similarity degree.

### CITATION LIST

### Patent Literature

[Patent Literature 1] Japanese Unexamined Patent Application Publication No. 2009-003488

[Patent Literature 2] International Patent Publication No. WO2017/131043

### SUMMARY OF INVENTION

### Technical Problem

When a user performs a job seeking activity or the like, the user preferably evaluates his/her career objectively. However, the above-described patent literatures do not disclose objectively evaluating a career of the user. Therefore, with the technique according to each of the above-described patent literatures, the user needs to determine his/her career by himself/herself from job offer information or the like.

The present disclosure has been made in order to solve such a problem, and an object thereof is to provide an information providing device, an information providing system, an information providing method, and a program, which are capable of objectively evaluating a career of a user.

### Solution to Problem

An information providing device according to the present disclosure includes: a job history acquisition means for acquiring job history information indicating a job history of a user; a similarity degree calculation means for calculating a similarity degree between the job history information and each of a plurality of pieces of job offer information; a first extraction means for extracting the job offer information of which the similarity degree is equal to or more than a predetermined criterion; a proper job level calculation means for calculating a current proper job level of the user by use of the extracted job offer information; and a proper job level display means for performing processing for displaying the calculated proper job level.

An information providing system according to the present disclosure includes: a user terminal configured to accept job history information indicating a job history of a user; and an information providing device configured to provide information relating to a job of the user, wherein the information providing device includes a job history acquisition means for acquiring the job history information from the user terminal, a similarity degree calculation means for calculating a similarity degree between the job history information and each of a plurality of pieces of job offer information, a first extraction means for extracting the job offer information of which the similarity degree is equal to or more than a predetermined criterion, a proper job level calculation means for calculating a current proper job level of the user by use of the extracted job offer information, and a proper job level display means for performing processing for displaying the calculated proper job level on the user terminal.

An information providing method according to the present disclosure includes: acquiring job history information indicating a job history of a user; calculating a similarity degree between the job history information and each of a plurality of pieces of job offer information; extracting the job offer information of which the similarity degree is equal to or more than a predetermined criterion; calculating a current proper job level of the user by use of the extracted job offer information; and performing processing for displaying the calculated proper job level.

A program according to the present disclosure causes a computer to achieve: a function of acquiring job history information indicating a job history of a user; a function of calculating a similarity degree between the job history information and each of a plurality of pieces of job offer information; a function of extracting the job offer information of which the similarity degree is equal to or more than a predetermined criterion; a function of calculating a current proper job level of the user by use of the extracted job offer information; and a function of performing processing for displaying the calculated proper job level.

### Advantageous Effects of Invention

According to the present disclosure, an information providing device, an information providing system, an information providing method, and a program, which are capable of objectively evaluating a career of a user, can be provided.

### BRIEF DESCRIPTION OF DRAWINGS

FIG. 1 is a diagram illustrating an outline of an information providing device according to an example embodiment of the present disclosure.

FIG. 2 is a diagram illustrating an information providing system according to a first example embodiment.

FIG. 3 is a diagram illustrating a configuration of an information providing device according to the first example embodiment.

FIG. 4 is a flowchart illustrating an information providing method executed by the information providing device according to the first example embodiment.

FIG. 5 is a diagram exemplifying a proper salary displayed by processing in a proper job level display unit according to the first example embodiment.

FIG. 6 is a diagram exemplifying a proper salary displayed by processing in a proper job level display unit according to the first example embodiment.

FIG. 7 is a diagram exemplifying a first display example of an insufficient job capability and a sufficient job capability.

FIG. 8 is a diagram exemplifying a second display example of an insufficient job capability.

FIG. 9 is a diagram exemplifying a third display example of an insufficient job capability.

FIG. 10 is a diagram exemplifying a fourth display example of an insufficient job capability and a sufficient job capability.

FIG. 11 is a diagram exemplifying a fifth display example of an insufficient job capability.

FIG. 12 is a flowchart illustrating a calculation method of an effect amount according to the first example embodiment.

FIG. 13 is a diagram exemplifying a histogram being associated with FIG. 6, supposing that a certain insufficient job capability is mastered.

FIG. 14 is a diagram illustrating a configuration of an information providing device according to a second example embodiment.

FIG. 15 is a flowchart illustrating an information providing method executed by the information providing device according to the second example embodiment.

FIG. 16 is a diagram illustrating a configuration of an information providing device according to a third example embodiment.

FIG. 17 is a flowchart illustrating an information providing method executed by the information providing device according to the third example embodiment.

FIG. 18 is a diagram exemplifying a prediction result displayed by a prediction result display unit according to the third example embodiment.

FIG. 19 is a diagram illustrating a configuration of an information providing device according to a fourth example embodiment.

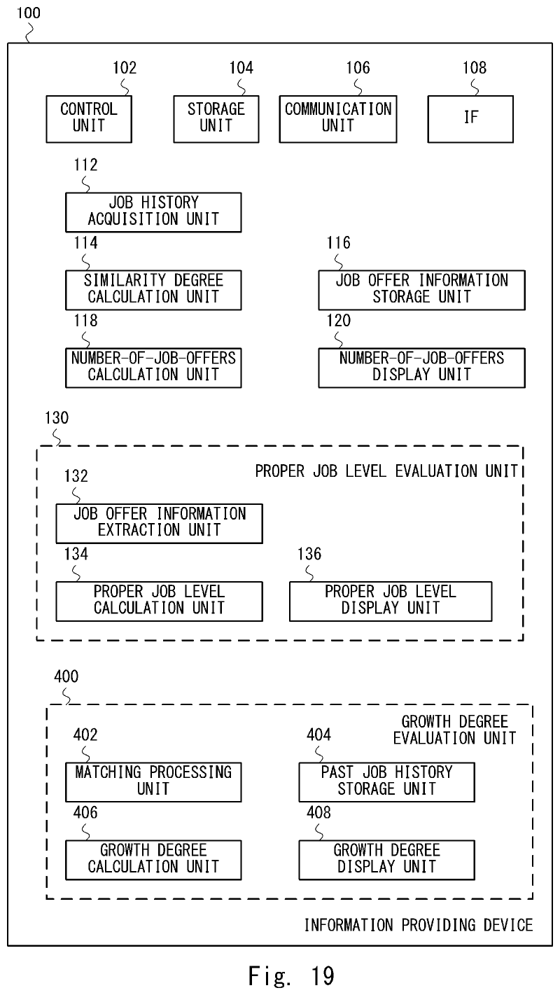

FIG. 20 is a flowchart illustrating an information providing method executed by the information providing device according to the fourth example embodiment.

### DESCRIPTION OF EMBODIMENTS

### Outline of Example Embodiment According to the Present Disclosure

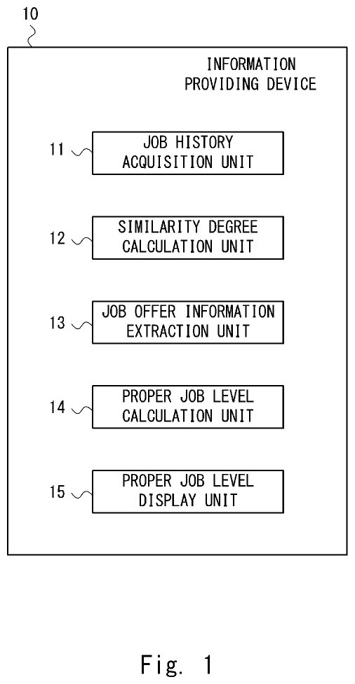

Prior to description of example embodiments according to the present disclosure, an outline of the example embodiments according to the present disclosure is described. FIG. 1 is a diagram illustrating an outline of an information providing device 10 according to an example embodiment of the present disclosure. The information providing device 10 is, for example, a computer such as a server. The information providing device 10 provides information relating to a job of a user.

The information providing device 10 includes a job history acquisition unit 11, a similarity degree calculation unit 12, a job offer information extraction unit 13, a proper job level calculation unit 14, and a proper job level display unit 15. The job history acquisition unit 11 functions as a job history acquisition means. The similarity degree calculation unit 12 functions as a similarity degree calculation means. The job offer information extraction unit 13 functions as a first extraction means. The proper job level calculation unit 14 functions as a proper job level calculation means. The proper job level display unit 15 functions as a proper job level display means.

The job history acquisition unit 11 acquires job history information indicating a job history of a user. The similarity degree calculation unit 12 calculates a similarity degree between the job history information and each of a plurality of pieces of job offer information. The job offer information extraction unit 13 extracts the job offer information of which the similarity degree is equal to or more than a predetermined criterion (first criterion). The proper job level calculation unit 14 calculates a proper job level of the user by use of the extracted job offer information. Herein, the job level is, for example, goodness of treatment, and indicated by a salary, a post, or the like. Moreover, the proper job level is treatment suited to a career of the user that is objectively evaluated and indicated by the job history information, and is, for example, a proper salary, a proper post, or the like. The proper job level display unit 15 performs processing for displaying the calculated proper job level. When the job history acquisition unit 11 acquires job history information from a user terminal described later, the proper job level display unit 15 may transmit, to the user terminal, screen data displaying a proper job level. Moreover, when the user inputs job history information by use of a user interface of the information providing device 10, the proper job level display unit 15 may display a proper job level on the user interface of the information providing device 10.

The information providing device 10 according to the present disclosure is configured as described above, and therefore, is capable of objectively evaluating a career of a user. Note that using an information providing system including the information providing device 10 and a user terminal also enables objectively evaluating a career of a user. Moreover, using an information providing method executed in the information providing device 10 and a program executing the information providing method also enables objectively evaluating a career of a user.

### First Example Embodiment

An example embodiment is described below with reference to the drawings. For clarification of description, the following description and the drawings are suitably subjected to omission and simplification. Moreover, the same reference sign is assigned to the same element in each of the drawings, and repeated description thereof is omitted according to need.

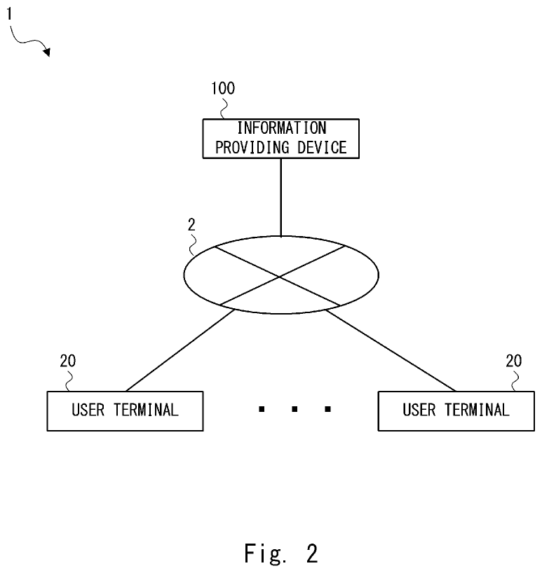

FIG. 2 is a diagram illustrating an information providing system 1 according to a first example embodiment. The information providing system 1 includes one or more user terminals 20, and an information providing device 100. The information providing device 100 is associated with (i.e., corresponds to) an information providing device 10 illustrated in FIG. 1. The user terminal 20 and the information providing device 100 are communicably connected to each other via a wired or wireless network 2.

The user terminal 20 is, for example, a computer. The user terminal 20 is, for example, a personal computer (PC), a portable terminal such as a smartphone, or the like of a user. The user inputs job history information of the user by use of the user terminal 20. Thus, the user terminal 20 accepts the job history information. The user terminal 20 transmits the job history information to the information providing device 10.

The information providing device 100 provides information relating to a job of a user. The information providing device 100 according to the first example embodiment acquires (receives) job history information from the user terminal 20, and calculates a current proper job level of the user from the job history information and previously stored job offer information. Further, the information providing device 100 performs processing for displaying the calculated proper job level on the user terminal 20. Note that although the proper job level is a proper salary in an example described below, the proper job level may be another treatment such as a proper post. Moreover, the information providing device 100 according to the first example embodiment performs processing for calculating job capabilities currently insufficient and sufficient for the user from the job history information and previously stored job offer information, and displaying the job capabilities on the user terminal 20.

Herein, the job history information includes, for example, individual information (a name, a birth date, an academic background, and the like) of the user, and data on a job capability of the user. Herein, the “job capability” includes a skill that the user has, and job experience of the user. The “skill” is, for example, a qualification, a programming capability, a foreign language usage capability, or the like. The “job experience” is, for example, a type of experienced job, an overseas service experience, experience as a manager, or the like.

Furthermore, the job offer information is, for example, a job offer advertisement formed by an enterprise or the like. The job offer information includes, for example, data on enterprise information (an enterprise name, a type of industry, a capital, the number of employees, a content of welfare, and the like) and a content of recruitment. The content of recruitment includes, for example, a type of job for recruitment, a scheduled service place, treatment, and an application condition. The treatment includes, for example, a post, a salary (annual income), and the like. The application condition includes, for example, an age range and a required job capability. The “required job capability” includes a necessary job capability and a preferred job capability.

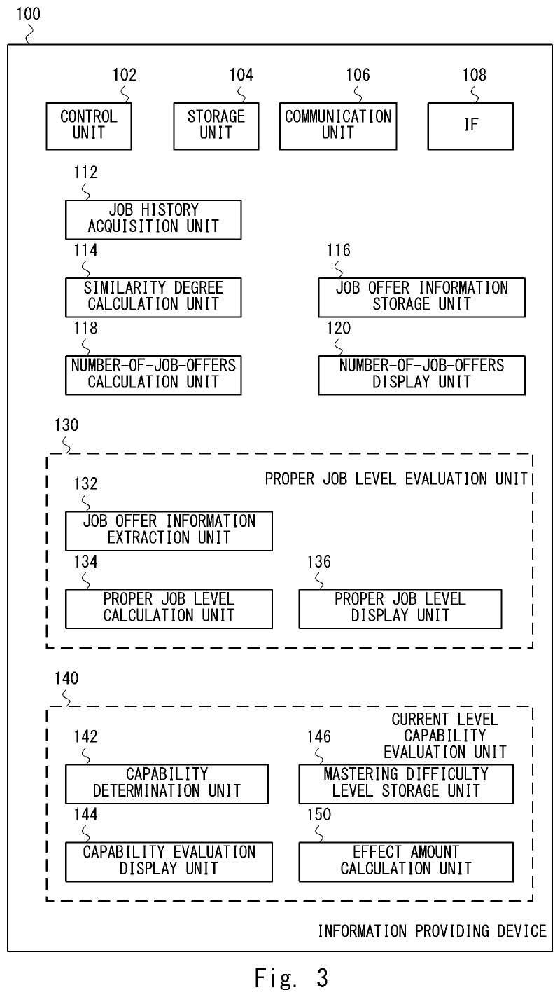

FIG. 3 is a diagram illustrating a configuration of the information providing device 100 according to the first example embodiment. The information providing device 100 includes, as a main hardware configuration, a control unit 102, a storage unit 104, a communication unit 106, and an interface unit 108 (IF; interface). The control unit 102, the storage unit 104, the communication unit 106, and the interface unit 108 are mutually connected via a data bus or the like. Note that the user terminal 20 also includes a hardware configuration illustrated in FIG. 3.

The control unit 102 is a processor such as a central processing unit (CPU). The control unit 102 has a function as an arithmetic device that performs control processing, arithmetic processing, and the like. The storage unit 104 is a storage device such as a memory or a hard disk. The storage unit 104 is, for example, a read only memory (ROM), a random access memory (RAM), or the like. The storage unit 104 has a function for storing a control program, an arithmetic program, or the like to be executed by the control unit 102. Moreover, the storage unit 104 has a function for transitorily storing processing data and the like. The storage unit 104 can include a database.

The communication unit 106 performs processing necessary for communicating with the user terminal 20 (and another device) via a network 2. The communication unit 106 can include a communication port, a router, a firewall, and the like. The interface unit 108 is, for example, a user interface (UI). The interface unit 108 includes an input device such as a keyboard, a touch panel, or a mouse, and an output device such as a display or a speaker. The interface unit 108 accepts an operation of data input by the user (operator), and outputs information to the user. The interface unit 108 may display a current proper job level of the user, and job capabilities currently insufficient and sufficient for the user.

The information providing device 100 according to the first example embodiment includes a job history acquisition unit 112, a similarity degree calculation unit 114, a job offer information storage unit 116, a number-of-job-offers calculation unit 118, a number-of-job-offers display unit 120, a proper job level evaluation unit 130, and a current level capability evaluation unit 140 (“each component”). The proper job level evaluation unit 130 includes a job offer information extraction unit 132, a proper job level calculation unit 134, and a proper job level display unit 136. The current level capability evaluation unit 140 includes a capability determination unit 142, a capability evaluation display unit 144, a mastering difficulty level storage unit 146, and an effect amount calculation unit 150.

The job history acquisition unit 112, the similarity degree calculation unit 114, the job offer information storage unit 116, the number-of-job-offers calculation unit 118, and the number-of-job-offers display unit 120 function as a job history acquisition means, a similarity degree calculation means, a job offer information storage means, a number-of-job-offers calculation means, and a number-of-job-offers display means, respectively. The proper job level evaluation unit 130 and the current level capability evaluation unit 140 function as a proper job level evaluation means and a current level capability evaluation means, respectively. Moreover, the job offer information extraction unit 132, the proper job level calculation unit 134, and the proper job level display unit 136 function as a job offer information extraction means (first extraction means), a proper job level calculation means, and a proper job level display means, respectively. Moreover, the capability determination unit 142, the capability evaluation display unit 144, the mastering difficulty level storage unit 146, and the effect amount calculation unit 150 function as a capability determination means, a capability evaluation display means, an acquisition difficulty level storage means, and an effect amount calculation means, respectively.

Note that each component can be achieved by executing a program by, for example, control of the control unit 102. More specifically, each component is achievable by execution of a program stored in the storage unit 104 by the control unit 102. Moreover, each component may be achieved by recording a necessary program in any non-volatile recording medium, and installing the program according to need. Moreover, each component is not limited to being achieved by software by a program, and may be achieved by a combination or the like of any of hardware, firmware, and software. Moreover, each component may be achieved by use of an integrated circuit programmable by a user, such as a field-programmable gate array (FPGA) or a microcomputer. In this case, a program constituted of each of the above-described components may be achieved by use of the integrated circuit. The above also applies to other example embodiments described later. Note that a specific function of each component is described later.

The job history acquisition unit 112 is associated with a job history acquisition unit 11 illustrated in FIG. 1. The job offer information storage unit 116 stores, for example, a plurality of pieces of job offer information acquired from an enterprise or the like. The similarity degree calculation unit 114 is associated with a similarity degree calculation unit 12 illustrated in FIG. 1. The job offer information extraction unit 132 is associated with a job offer information extraction unit 13 illustrated in FIG. 1. The proper job level calculation unit 134 is associated with a proper job level calculation unit 14 illustrated in FIG. 1. The proper job level display unit 136 is associated with a proper job level display unit 15 illustrated in FIG. 1.

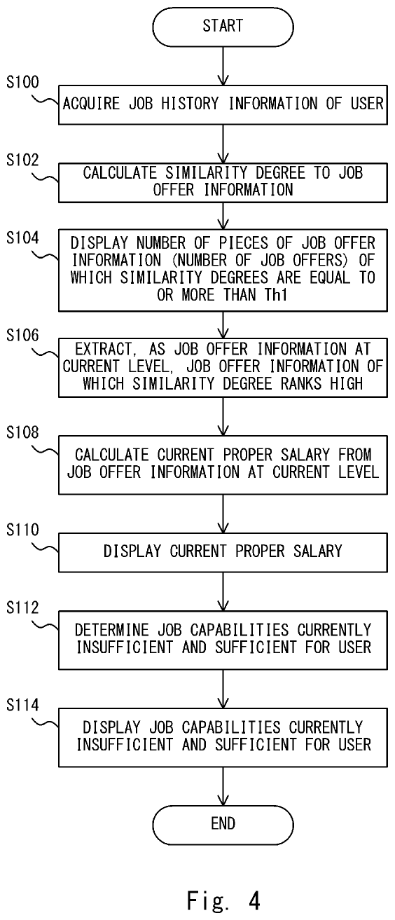

The proper job level evaluation unit 130 evaluates an objective proper job level (a proper salary or the like) for a current job capability of the user. The current level capability evaluation unit 140 evaluates a current job capability of the user for job offer information. The mastering difficulty level storage unit 146 stores a difficulty level table associating each job capability with a difficulty level of mastering. The effect amount calculation unit 150 calculates, with regard to each job capability that is not mastered by the user, an effect amount being associated with an increase amount of a job value of the user supposing that the user has mastered the job capability. The job value is described later. The other components are described later by use of FIG. 4.

FIG. 4 is a flowchart illustrating an information providing method executed by the information providing device 100 according to the first example embodiment. The job history acquisition unit 112 acquires job history information of a user from the user terminal 20 (step S100). The similarity degree calculation unit 114 calculates a similarity degree (matching ratio) between the job history information and each of a plurality of pieces of job offer information (step S102). For example, the similarity degree calculation unit 114 converts contents of the job history information and the job offer information into a common language by use of a previously stored experience database, a skill language database, and an expression database by a same content clustering by an implication analysis technique, and thereby replaces the contents with a general word. Then, the similarity degree calculation unit 114 performs matching processing with the same noun including paraphrase and an appearance frequency of a document, and calculates a similarity degree between the job history information and the job offer information. Alternatively, the similarity degree calculation unit 114 may calculate a similarity degree between the job history information and each of a plurality of pieces of job offer information by a method described in each of the above-described patent literatures. Alternatively, after learning is performed by machine learning such as deep learning by repeatedly performing matching processing manually, the similarity degree calculation unit 114 may calculate a similarity degree between the job history information and job offer information by use of a learning result (learning model).

The number-of-job-offers display unit 120 performs processing in such a way as to display, as the number of job offers, the number of pieces of job offer information of which similarity degrees are equal to or more than a predetermined threshold value Th1 (step S104). Specifically, the number-of-job-offers calculation unit 118 calculates (counts) the number of pieces of job offer information of which similarity degrees calculated by the processing in step S102 are equal to or more than the threshold value Th1. The calculated number of pieces of job offer information becomes the number of job offers being the number of pieces of job offer information hit by the matching processing (S102). The Th1 is, for example, 50%, but the value of the Th1 may be any value. Then, the number-of-job-offers display unit 120 performs processing for displaying the number of job offers on the user interface of the user terminal 20, by controlling the communication unit 106. Consequently, the number of job offers is displayed on the user interface of the user terminal 20.

The job offer information extraction unit 132 extracts, as job offer information at a current level (current-level job offer information), the job offer information of which a similarity degree ranks high (step S106). In other words, the job offer information extraction unit 132 extracts job offer information at a current level (first job offer information) being job offer information of which a similarity degree becomes equal to or more than a predetermined criterion. Specifically, the job offer information extraction unit 132 extracts, as current-level job offer information, the job offer information of which a similarity degree ranks high, among pieces of the job offer information hit by the processing in S104. For example, the job offer information extraction unit 132 may extract, as current-level job offer information, the job offer information of which a similarity degree is equal to or more than a predetermined threshold value Th2 (>Th1). In this case, the Th2 is, for example, 70%, but may be any value being more than the Th1. Alternatively, the job offer information extraction unit 132 may extract, as current-level job offer information, A% of the job offer information of which a similarity degree ranks high, among pieces of the job offer information hit by the processing in S104. Herein, A is a predetermined value, and is, for example, 20(%). In a case of A =20(%), when the number of hits (the number of job offers) in S104 is fifty, top ten pieces of job offer information in similarity degree are extracted as current-level job offer information. Note that the above-described threshold value Th2 and A(%) are each associated with the predetermined criterion (first criterion).

The proper job level calculation unit 134 calculates a current proper salary of the user from the current-level job offer information extracted by the processing in S106 (step S108). In other words, the proper job level calculation unit 134 calculates a proper job level of the user, by use of the extracted current-level job offer information (first job offer information). Specifically, the proper job level calculation unit 134 extracts a salary in a content of recruitment indicated in each of the extracted pieces of current-level job offer information. Then, the proper job level calculation unit 134 calculates an average value of the extracted salaries, and determines the average value as a proper salary. Moreover, the proper job level calculation unit 134 may calculate an upper limit and a lower limit of the extracted salary. Moreover, the proper job level calculation unit 134 may calculate a median value of the extracted salary.

The proper job level display unit 136 performs processing for displaying the current proper salary of the user calculated by the processing in S108 (step S110). In other words, the proper job level display unit 136 performs processing for displaying the calculated proper job level. Specifically, the proper job level display unit 136 performs processing for displaying a proper salary on the user interface of the user terminal 20, by controlling the communication unit 106. Consequently, the proper salary is displayed on the user interface of the user terminal 20.

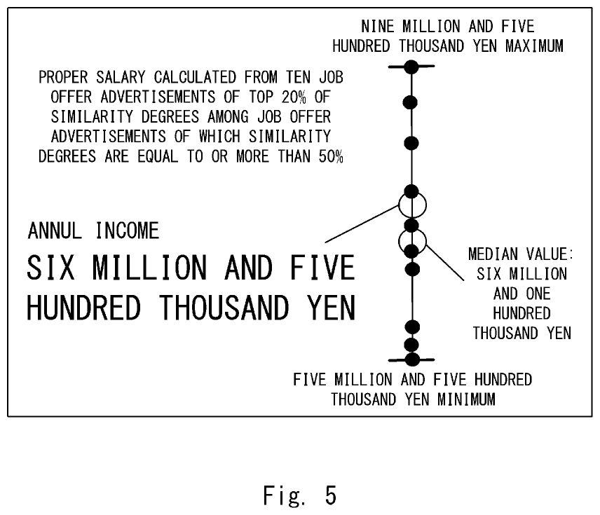

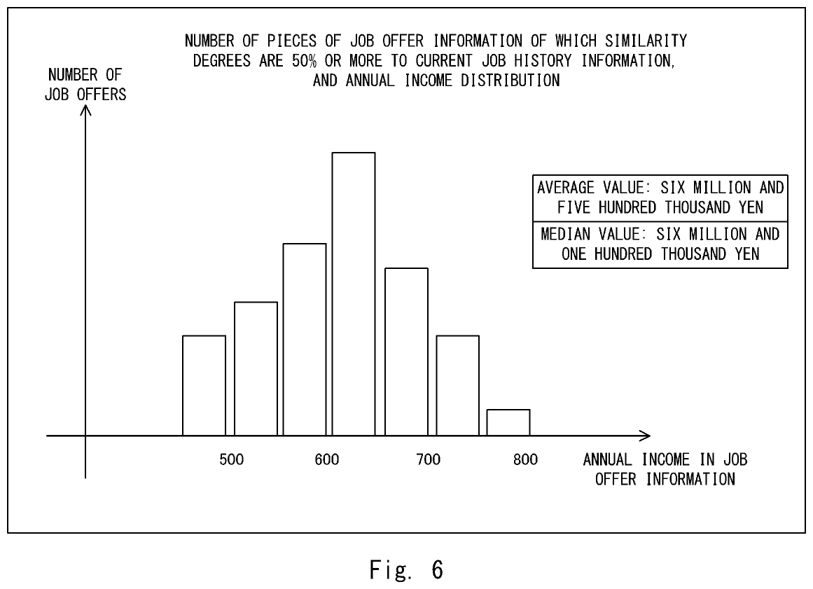

FIGS. 5 and 6 are diagrams each exemplifying a proper salary displayed by processing in the proper job level display unit 136 according to the first example embodiment. Note that FIGS. 5 and 6 are independent of each other, and therefore, do not each illustrate a result for the same job offer information. In the example illustrated in FIG. 5, a proper salary calculated from ten job offer advertisements being top 20% of job offer advertisements among job offer advertisements of which similarity degrees are equal to or more than 50% is illustrated. In the example illustrated in FIG. 5, “annual income of six million and five hundred thousand yen” is displayed, with an average of salaries indicated by ten job offer advertisements as a proper salary. Moreover, in the example illustrated in FIG. 5, a maximum value and a minimum value of the salaries indicated by ten job offer advertisements, and a median value are also illustrated. Therefore, in the example illustrated in FIG. 5, a width of the current proper salary of the user is also illustrated. The width may be determined as a “proper salary”. Alternatively, the median value may be determined as a “proper salary”.

In the example illustrated in FIG. 6, a distribution (histogram) indicating the number of job offers (frequency) in each class of salary in job offer information of which a similarity degree is 50% is illustrated for a current job history document (job history information) of the user. Moreover, an average value and a median value of salaries are further illustrated in the distribution exemplified in FIG. 6

As described above, the information providing device 100 according to the first example embodiment is configured in such a way as to calculate a proper salary by use of job history information of a user and job offer information, and display the proper salary. This enables the user to recognize his/her objective proper salary. In other words, the information providing device 100 according to the first example embodiment becomes capable of objectively evaluating a career of the user. Consequently, the user can recognize his/her objective value in a job, and therefore, can enhance motivation of self-improvement.

The capability determination unit 142 determines job capabilities currently insufficient and sufficient for the user in the job offer information extracted in S106 (step S112). Specifically, the capability determination unit 142 converts contents of the job history information and the job offer information into a common language, as in the processing in S102. Then, the capability determination unit 142 extracts ones being relevant to the job capabilities (a skill and experience) from the job history information and the job offer information extracted in S106, respectively, and extracts a difference by comparing the relevant ones. The capability determination unit 142 determines, as job capabilities being sufficient (sufficient job capabilities), the job capabilities coinciding with each other in the job history information and the job offer information. On the other hand, the capability determination unit 142 determines, as a job capability being insufficient (insufficient job capability), a job capability that is indicated in the job offer information but is not indicated in the job history information.

The capability evaluation display unit 144 performs processing for displaying job capabilities currently insufficient and sufficient for the user (step S114). Specifically, the capability evaluation display unit 144 performs processing for displaying the insufficient job capability and the sufficient job capability on the user interface of the user terminal 20, by controlling the communication unit 106. Consequently, at least one of the insufficient job capability and the sufficient job capability is displayed on the user interface of the user terminal 20. A display example of an insufficient job capability and a sufficient job capability is described below. Note that a plurality of display examples illustrated below are independent of each other, and therefore, do not each illustrate a result for the same job offer information.

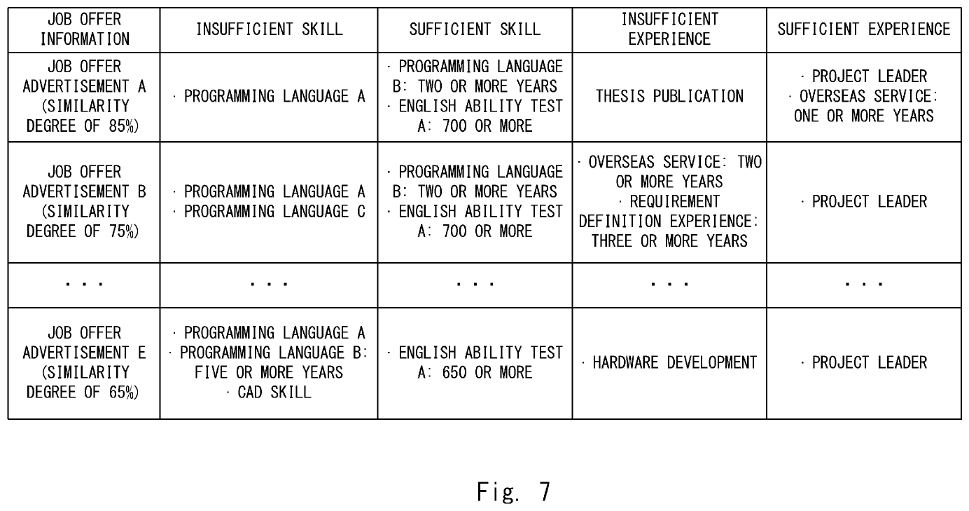

FIG. 7 is a diagram exemplifying a first display example of an insufficient job capability and a sufficient job capability. In the first display example, the capability evaluation display unit 144 performs processing for displaying a table associating the current-level job offer information (a job offer advertisement) extracted by the processing in S106 with insufficiency and sufficiency of job capabilities (a skill and experience) for pieces of the job offer information.

For example, in the example of FIG. 7, a job offer advertisement having the height similarity degree among a plurality of job offer advertisements is a job offer advertisement A having a similarity degree of 85%. Among skills indicated in the job offer advertisement A, a skill that is not mastered by the user is “programming language A”, and skills mastered by the user are “two or more years of use of programming language B” and “acquisition of 700 scores or more in English ability test A”. Among experiences indicated in the job offer advertisement A, an experience that is not mastered by the user is “thesis publication”, and experiences mastered by the user are “project leader” and “one or more years of overseas service”. Consequently, the user can easily recognize a similarity degree (matching ratio) of the job offer advertisement A, and that “programming language A” and “thesis publication” are not mastered among job capabilities required in the job offer advertisement A.

Furthermore, the user can easily recognize that “two or more years of use of programming language B”, “acquisition of 700 scores or more in English ability test A”, “project leader”, and “one or more years of overseas service” are already mastered, among job capabilities indicated in the job offer advertisement A. The same also applies to other job offer advertisements (a job offer advertisement B, a job offer advertisement E, and the like). Therefore, the user can easily recognize his/her insufficient job capability and sufficient job capability in job offer information of which a similarity degree is high. This enables the user to objectively evaluate his/her career. Thus, the user can enhance motivation of self-improvement, such as which job capability to master.

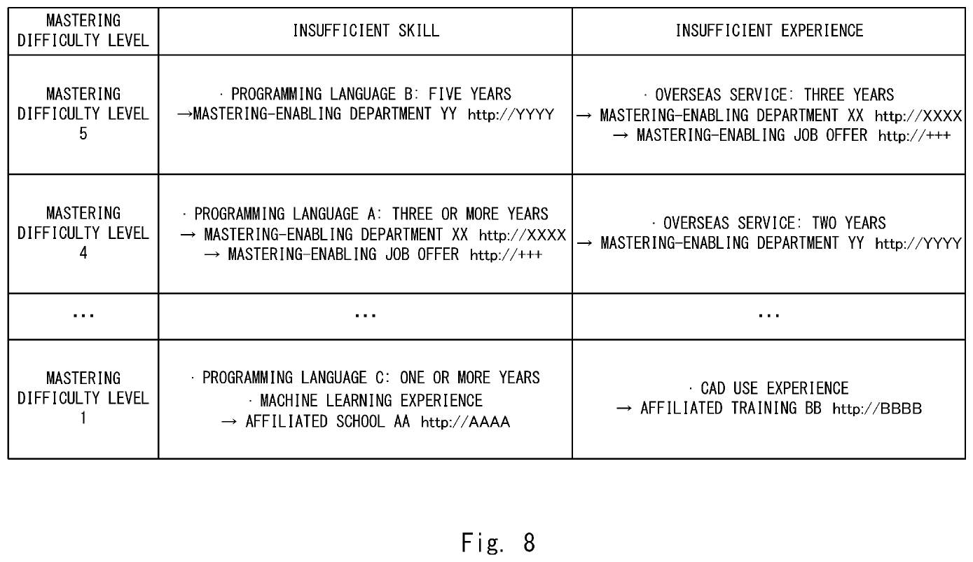

FIG. 8 is a diagram exemplifying a second display example of an insufficient job capability. In the second display example, the capability evaluation display unit 144 performs processing for displaying an insufficient job capability in an order according to a difficulty level of mastering the insufficient job capability (mastering difficulty level). The capability evaluation display unit 144 performs processing for displaying an insufficient job capability determined in the processing in S112 in an order according to the mastering difficulty level, with reference to a difficulty level table stored in the mastering difficulty level storage unit 146.

In the example illustrated in FIG. 8, insufficient job capabilities (an insufficient skill and an insufficient experience) are displayed in descending order of mastering difficulty levels. For example, an insufficient skill and an insufficient experience for “mastering difficulty level: 5” being the highest mastering difficulty level are “five or more years of use of programming language B” and “three years of overseas service”, respectively. Thus, the user can easily recognize a mastering difficulty level of his/her insufficient job capability. Note that an insufficient job capability may be displayed in ascending order of mastering difficulty levels.

Furthermore, the difficulty level table may associate each job capability with mastering method information indicating a method that enables mastering. Then, as illustrated in FIG. 8, to a column of insufficient job capabilities (an insufficient skill and an insufficient experience), mastering method information thereof may be added. In other words, the capability evaluation display unit 144 performs processing for displaying information indicating a method of mastering an insufficient job capability.

Herein, in the example of FIG. 8, the mastering method information indicates a name of an institution (an in-house department, a school, training, or the like) available for mastering, and a uniform resource locator (URL) indicating the institution. Thus, the information providing device 100 can recommend a method for mastering an insufficient job capability of the user. This enables the user to easily recognize a method for mastering his/her insufficient job capability. For example, the user can easily recognize that the user can master “five or more years of use of programming language B” of “mastering difficulty level: 5” in a department “YY”. Therefore, motivation of self-improvement of the user can be enhanced. Note that the mastering method information may be displayed in not only the second display example but also other display examples.

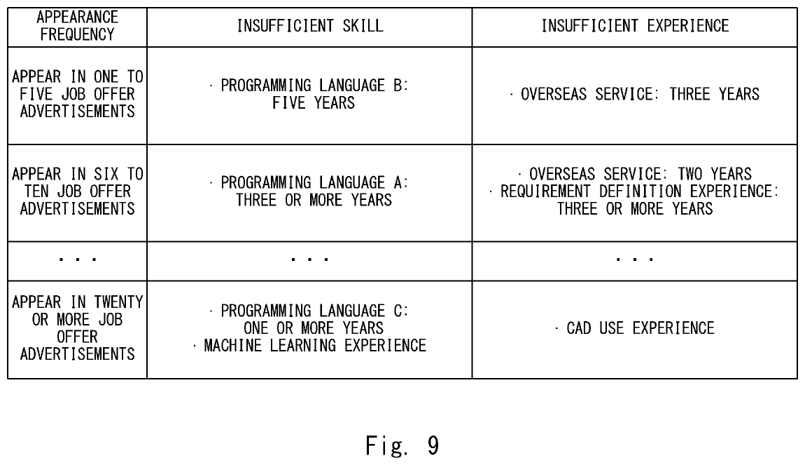

FIG. 9 is a diagram exemplifying a third display example of an insufficient job capability. In the third display example, the capability evaluation display unit 144 performs processing for displaying an insufficient job capability in an order according to a frequency at which an insufficient job capability appears in current-level job offer information extracted in S106. Specifically, the capability evaluation display unit 144 counts how many pieces of current-level job offer information indicate each insufficient job capability of the user determined in S112, and calculates the counted number as an appearance frequency of the insufficient job capability. The capability evaluation display unit 144 performs processing for displaying an insufficient job capability in an order according to the calculated appearance frequency.

Although insufficient job capabilities (an insufficient skill and an insufficient experience) are displayed in ascending order of appearance frequencies in the example illustrated in FIG. 9, the insufficient job capabilities may be displayed in descending order of appearance frequencies. For example, an insufficient skill and an insufficient experience of appearance frequencies “1 to 5” are “five or more years of use of programming language B” and “three years of overseas service”, respectively. Thus, the user can easily recognize how many pieces of job offer information represent his/her insufficient job capability. In other words, the user can easily recognize how many pieces of job offer information require his/her insufficient job capability. Therefore, the user can enhance motivation of self-improvement, such as which job capability to master.

Note that, although insufficient job capabilities (an insufficient skill and an insufficient experience) are displayed in the example illustrated in FIG. 9, a sufficient job capability may be displayed. In this case, the user can easily recognize how many pieces of job offer information require his/her sufficient job capability.

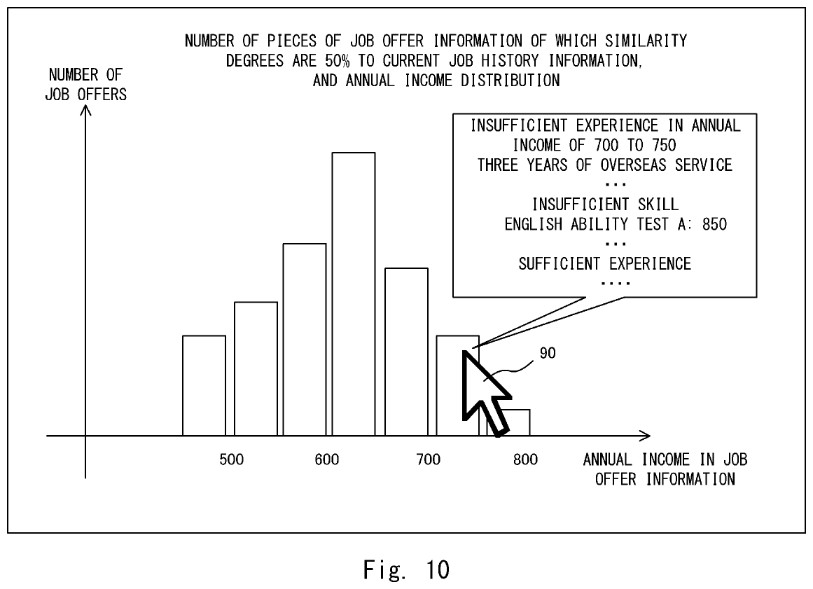

FIG. 10 is a diagram exemplifying a fourth display example of an insufficient job capability and a sufficient job capability. In the fourth display example, the capability evaluation display unit 144 performs processing in such a way that, when a pointer 90 is laid over a bar (bin) indicating each section of an annual income in a histogram illustrated in FIG. 6, an insufficient job capability and a sufficient job capability regarding job offer information relating the section are displayed. Specifically, the capability evaluation display unit 144 associates each section of an annual income in the histogram illustrated in FIG. 6 with an insufficient job capability and a sufficient job capability regarding job offer information relating the section. The capability evaluation display unit 144 performs processing in such a way that, when the user lays the pointer over a bar indicating a certain section of an annual income (mouseover) by operating a device (a mouse or the like) of the user terminal 20, an insufficient job capability and a sufficient job capability being associated with the section are displayed. For example, when the pointer is laid over a bar indicating a certain section of an annual income, an insufficient job capability and a sufficient job capability being associated with the section are displayed by, for example, tooltip or pop-up. Thus, the user can easily recognize which job capability is insufficient or sufficient in which annual income section.

Note that, in the example illustrated in FIG. 10, when the pointer is laid over a bar, an insufficient job capability and a sufficient job capability being associated with the section are displayed, but such a configuration is not a limitation. In a case of the user terminal 20 having a touch panel, including a smartphone or the like, by touching, with a finger, a bar indicating each section of an annual income, an insufficient job capability and a sufficient job capability regarding job offer information relating the section may be displayed.

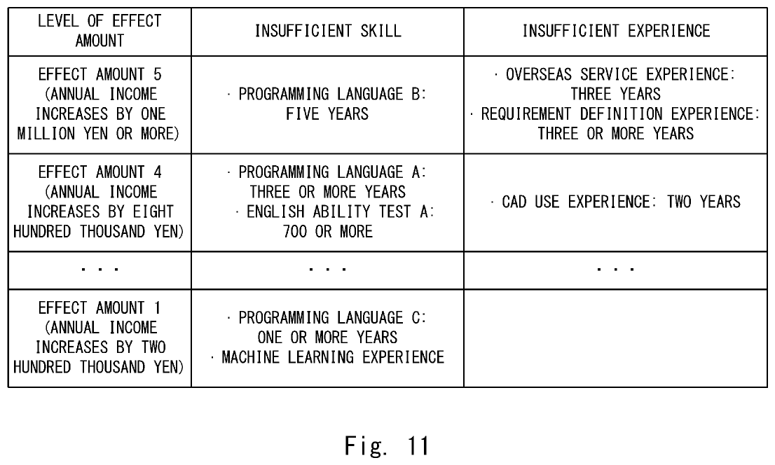

FIG. 11 is a diagram exemplifying a fifth display example of an insufficient job capability. In the fifth display example, the capability evaluation display unit 144 performs processing for displaying an insufficient job capability in an order according to an effect amount of an insufficient job capability. Herein, the effect amount is associated with an increase amount of a job value of the user supposing that an insufficient job capability is mastered. Moreover, the job value is associated with at least one of a job level (a proper salary or the like) for job history information of the user, and the number of job offers (the number of pieces of job offer information of which similarity degrees are equal to or more than a predetermined criterion (equal to or more than the threshold value Th1)) for job history information of the user. In other words, an effect amount of a certain insufficient job capability is associated with at least one of an increase amount of a proper salary, and an increase amount of the number of job offers, supposing that the insufficient job capability is mastered. Note that an effect amount is calculated by the effect amount calculation unit 150 as described above. Specific processing of the effect amount calculation unit 150 is described later. Note that a case where an effect amount is associated with an increase amount of a proper salary is described in the following description.

In the example of FIG. 11, a level of an effect amount of such an insufficient job capability that an annual income increases by one million yen or more supposing that the insufficient job capability is mastered is determined as an “effect amount 5”. Moreover, it is assumed that a level of an effect amount of such an insufficient job capability that an annual income increases by less than one million yen and eight hundred thousand yen or more supposing that the insufficient job capability is mastered is determined as an “effect amount 4”. Moreover, it is assumed that a level of an effect amount of an insufficient job capability with an annual income increase being less than two hundred thousand yen supposing that the insufficient job capability is mastered is determined as an “effect amount 1”. For example, insufficient job capabilities of the “effect amount 5” are “five or more years of use of programming language B”, “three years of overseas service”, and “three or more years of requirement definition experience”.

Thus, the user can easily recognize which insufficient job capability to master and how much effect may be gained accordingly. Therefore, the user can enhance motivation of self-improvement. In a case of the example of FIG. 11, since it is presumed that an annual income increases by one million yen or more by mastering, for example, an insufficient skill “five or more years of use of programming language B”, the user can enhance motivation of mastering the insufficient skill.

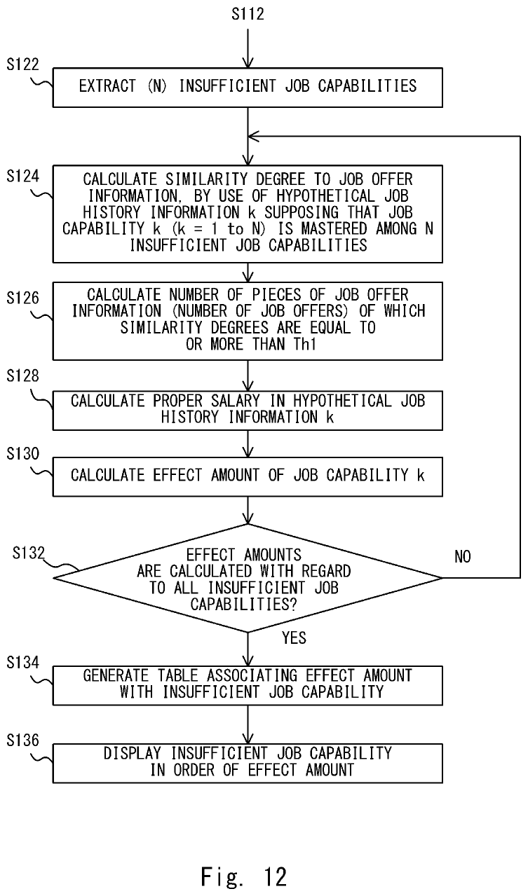

FIG. 12 is a flowchart illustrating a calculation method of an effect amount according to the first example embodiment. After the processing in S112 illustrated in FIG. 4, the effect amount calculation unit 150 extracts the insufficient job capability determined in the processing in S112 (step S122). Herein, the number of extracted insufficient job capabilities is N.

The information providing device 100 calculates a similarity degree to job offer information, by use of hypothetical job history information k being job history information supposing that one job capability k (k is an integer of 1 to N) is mastered among the N insufficient job capabilities (step S124). Specifically, the effect amount calculation unit 150 generates the hypothetical job history information k by adding, to job history information of the user, information that the job capability k is already mastered. Then, the effect amount calculation unit 150 instructs the similarity degree calculation unit 114 to calculate a similarity degree between the hypothetical job history information k and the job offer information stored in the job offer information storage unit 116. Thus, the similarity degree calculation unit 114 calculates a similarity degree between the hypothetical job history information k and the job offer information, as in the processing in S102.

The information providing device 100 calculates, as the number of job offers, the number of pieces of job offer information of which similarity degrees calculated by the processing in S124 are equal to or more than the Th1 (step S126). Specifically, the effect amount calculation unit 150 instructs the number-of-job-offers calculation unit 118 to calculate the number of job offers regarding the hypothetical job history information k. Thus, the number-of-job-offers calculation unit 118 calculates the number of pieces of job offer information of which similarity degrees calculated by the processing in step S124 are equal to or more than the threshold value Th1 (e.g., 50%), as in the processing in S104.

The information providing device 100 calculates a proper salary in the hypothetical job history information k (step S128). Specifically, the effect amount calculation unit 150 instructs the proper job level evaluation unit 130 to calculate a proper salary in the hypothetical job history information k. Thus, the job offer information extraction unit 132 extracts, as hypothetical-level job offer information (hypothetical-level job offer information k), job offer information of which a similarity degree to the hypothetical job history information k ranks high, as in the processing in S106. Moreover, the proper job level calculation unit 134 calculates a proper salary in the hypothetical job history information k of the user from the extracted hypothetical-level job offer information k, as in the processing in S108.

The effect amount calculation unit 150 calculates an effect amount of the job capability k (step S130). Specifically, the effect amount calculation unit 150 calculates a difference between the proper salary in the hypothetical job history information k calculated by the processing in step S128 and the current proper salary calculated by the processing in step S110. The effect amount calculation unit 150 determines a level of an effect amount being associated with the difference (a salary increase amount). Note that the effect amount calculation unit 150 may determine the salary increase amount itself as an effect amount. Moreover, the effect amount calculation unit 150 may calculate a difference between the number of job offers regarding the hypothetical job history information k calculated by the processing in S126 and the number of job offers calculated by the processing in S104, and determine a level of an effect amount being associated with the difference (the number of increased job offers). Note that, in this case, the effect amount calculation unit 150 may determine the number of increased job offers itself as an effect amount.

The effect amount calculation unit 150 determines whether effect amounts are calculated with regard to all insufficient job capabilities (step S132). Specifically, the effect amount calculation unit 150 determines whether effect amounts are calculated for all job capabilities k of k=1 to N. When effect amounts are not calculated for all insufficient job capabilities (NO in step S132), the effect amount calculation unit 150 performs control in such a way as to perform processing in S124 to S130 with regard to an insufficient job capability of which an effect amount is not calculated.

On the other hand, when effect amounts are calculated for all insufficient job capabilities (YES in step S132), the effect amount calculation unit 150 generates a table associating an effect amount with an insufficient job capability (step S134). Then, the capability evaluation display unit 144 performs processing in such a way that an insufficient job capability is displayed in an order of an effect amount, by use of the table generated by the processing in step S134 (step S136).

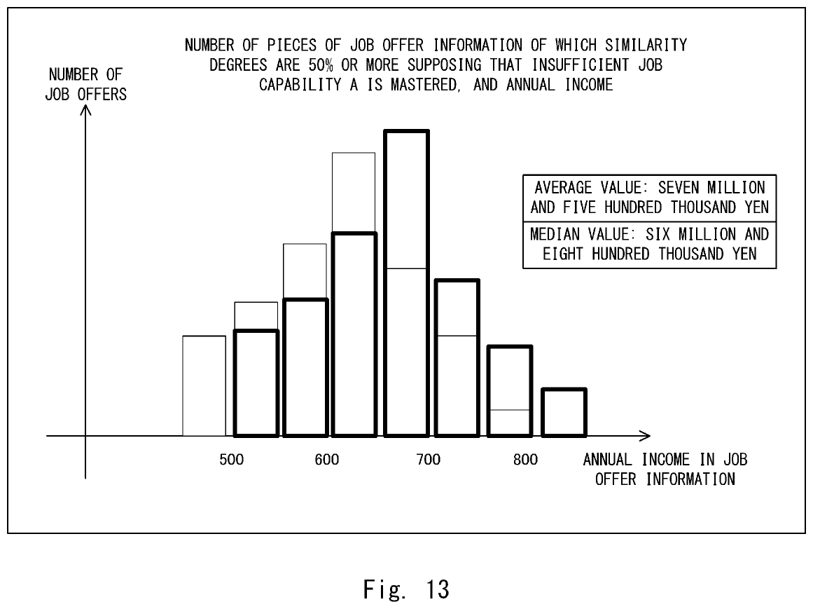

FIG. 13 is a diagram exemplifying a histogram (distribution) being associated with FIG. 6, supposing that a certain insufficient job capability is mastered. The effect amount calculation unit 150 may instruct the proper job level display unit 136 to display a histogram by use of hypothetical job history information, as exemplified in FIG. 13, supposing that an insufficient job capability A is mastered. FIG. 13 illustrates, with a thick line, a histogram supposing that an insufficient job capability is mastered, and illustrates, with a thin line, a histogram (illustrated in FIG. 6) regarding current actual job history information. Note that, as exemplified in FIG. 13, an average value and a median value of salaries supposing that an insufficient job capability is mastered may be further illustrated.

By displaying the histogram exemplified in FIG. 13 on the user terminal 20, the user can easily recognize how a section of an annual income and the number of job offers in the section shift supposing that an insufficient job capability A is mastered. Consequently, since the user can recognize a change in his/her objective job value when the insufficient job capability A is mastered, the user can enhance motivation of self-improvement.

### Second Example Embodiment

Next, a second example embodiment is described with reference to the drawings. For clarification of description, the following description and the drawings are suitably subjected to omission and simplification. Moreover, the same reference sign is assigned to the same element in each of the drawings, and repeated description thereof is omitted according to need. Note that, since a system configuration according to the second example embodiment is substantially similar to that illustrated in FIG. 2, description thereof is omitted.

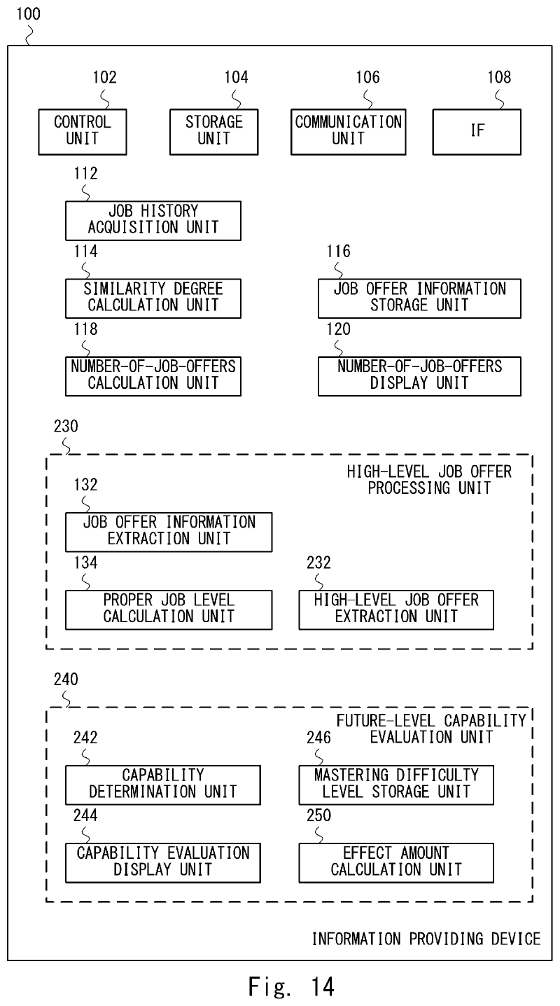

FIG. 14 is a diagram illustrating a configuration of an information providing device 100 according to the second example embodiment. Since a hardware configuration of the information providing device 100 according to the second example embodiment is substantially similar to that according to the first example embodiment, description thereof is omitted.

The information providing device 100 according to the second example embodiment includes a job history acquisition unit 112, a similarity degree calculation unit 114, a job offer information storage unit 116, a number-of-job-offers calculation unit 118, and a number-of-job-offers display unit 120. The information providing device 100 according to the second example embodiment further includes a high-level job offer processing unit 230 and a future-level capability evaluation unit 240. The high-level job offer processing unit 230 includes a job offer information extraction unit 132, a proper job level calculation unit 134, and a high-level job offer extraction unit 232. The future-level capability evaluation unit 240 includes a capability determination unit 242, a capability evaluation display unit 244, a mastering difficulty level storage unit 246, and an effect amount calculation unit 250.

The high-level job offer processing unit 230 and the future-level capability evaluation unit 240 function as a high-level job offer processing means and a future-level capability evaluation means, respectively. The high-level job offer extraction unit 232 functions as a high-level job offer extraction means (second extraction means). The capability determination unit 242, the capability evaluation display unit 244, the mastering difficulty level storage unit 246, and the effect amount calculation unit 250 function as a capability determination means, a capability evaluation display means, a mastering difficulty level storage means, and an effect amount calculation means, respectively. Unless otherwise stated, functions of other components are substantially similar to those according to the first example embodiment.

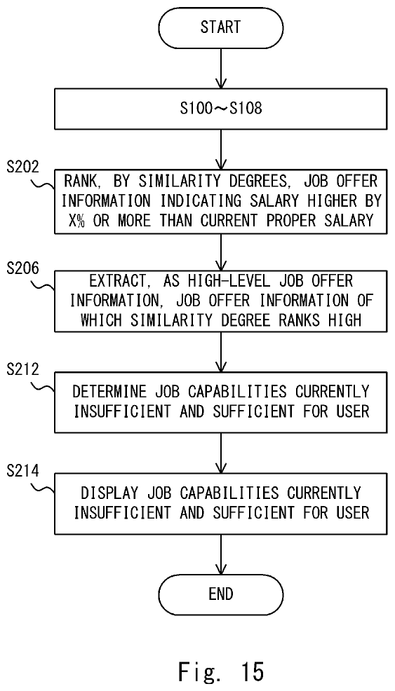

The high-level job offer processing unit 230 performs processing regarding job offer information (high-level job offer information) being associated with a level higher than a current job level of a user. The high-level job offer information is described later. The future-level capability evaluation unit 240 evaluates a job capability of the user at a future level. The mastering difficulty level storage unit 246 stores a difficulty level table associating each job capability with a difficulty level of mastering, similarly to a mastering difficulty level storage unit 146. The effect amount calculation unit 250 calculates, with regard to high-level job offer information, an effect amount being associated with an increase amount of a job value of the user in each job capability that is not mastered by the user, supposing that the job capability is mastered, by processing similar to that of an effect amount calculation unit 150. In other words, the effect amount calculation unit 250 is capable of executing the processing illustrated in FIG. 12. Other components are described later by use of FIG. 15.

FIG. 15 is a flowchart illustrating an information providing method executed by the information providing device 100 according to the second example embodiment. First, the information providing device 100 performs processing in S100 to S108 illustrated in FIG. 4. Then, the high-level job offer extraction unit 232 ranks, by similarity degrees, job offer information indicating a salary higher by X% (X is a predetermined value) or more than a current proper salary calculated in step S108 (step S202). Further, the high-level job offer extraction unit 232 extracts, as high-level job offer information, job offer information of which a similarity degree ranks high, as in the processing in S106 (step S206). In other words, the high-level job offer extraction unit 232 extracts high-level job offer information of which a similarity degree between a plurality of pieces of job offer information indicating job levels being equal to or more than a predetermined criterion (second criterion) for a proper job level and job history information is equal to or more than a predetermined criterion (first criterion).

Specifically, the high-level job offer extraction unit 232 limits to job offer information indicating a salary higher by X% than a current proper salary calculated in step S108, and ranks pieces of the limited job offer information by similarity degrees. In other words, when a proper salary calculated by the processing in S108 is P ten thousand yen, the high-level job offer extraction unit 232 extracts job offer information indicating a salary being equal to or more than P+P×(X/100) [ten thousand yen]. For example, when P=600 (ten thousand yen), X=10(%), job offer information indicating a salary being equal to or more than six million and six hundred thousand yen is extracted.

Then, the high-level job offer extraction unit 232 re-ranks the extracted job offer information in descending order of similarity degrees calculated by the processing in S102. Then, the high-level job offer extraction unit 232 extracts, as job offer information at a high level (high-level job offer information), job offer information of which a similarity degree ranks high, among pieces of the re-ranked job offer information. For example, the high-level job offer extraction unit 232 may extract, as high-level job offer information, A% of job offer information of which a similarity degree ranks high, among pieces of the job offer information ranked by the processing in S202. Herein, A is a predetermined value, and is, for example, 20(%). In a case of A=20(%), when pieces of the job offer information ranked in S202 are thirty, top six pieces of the job offer information in similarity degree are extracted as high-level job offer information.

Note that job offer information indicating a salary higher by X% or more than a current proper salary is ranked by similarity degrees in the processing in S202, but such a configuration is not a limitation. For example, the high-level job offer extraction unit 232 may rank, by similarity degrees, job offer information indicating a salary higher by X′ ten thousand yen (X′ is a predetermined value) than a current proper salary. In other words, the “criterion (second criterion)” for a “job level being equal to or more than a predetermined criterion for a proper job level” is not limited to X(%).

The capability determination unit 242 determines job capabilities currently insufficient and sufficient for the user for the high-level job offer information extracted in S206, as in the processing in S112 (step S212). In other words, the capability determination unit 242 determines an insufficient job capability insufficient for the user for the high-level job offer information, based on a difference between a job capability of the user indicated in job history information and a job capability indicated in the high-level job offer information.

The capability evaluation display unit 244 performs processing for displaying job capabilities currently insufficient and sufficient for the user for the high-level job offer information extracted in S206, as in the processing in S114 (step S214). In other words, the capability evaluation display unit 244 performs processing for displaying the insufficient job capability determined in the processing in S212. Consequently, at least one of the insufficient job capability and the sufficient job capability for the high-level job offer information is displayed on a user interface of the user terminal 20. Note that display examples of an insufficient job capability and a sufficient job capability are substantially similar to those exemplified by use of FIGS. 7 to 13. In other words, the capability evaluation display unit 244 performs processing in such a way as to display at least one of insufficient job capability and sufficient job capability for the high-level job offer information, as illustrated in FIGS. 7 to 13.

As described above, the information providing device 100 according to the second example embodiment is configured in such a way as to determine and display an insufficient job capability for job offer information indicating a salary higher than a proper salary. Thus, the user can easily recognize a job capability insufficient in aiming at a job level higher than his/her current job level. Therefore, the user can enhance motivation of self-improvement, such as which job capability to master. Moreover, the user becomes capable of objectively evaluating his/her career.

The capability evaluation display unit 244 of the information providing device 100 according to the second example embodiment is configured in such a way as to perform processing for displaying an insufficient job capability in an order according to a difficulty level of mastering the insufficient job capability, as illustrated in FIG. 8. Thus, the user can easily recognize a mastering difficulty level of a job capability insufficient in aiming at a job level higher than his/her current job capability. Further, the capability evaluation display unit 244 of the information providing device 100 according to the second example embodiment may perform processing for adding and displaying a mastering method information indicating a method that enables mastering an insufficient job capability, as illustrated in FIG. 8. This enables the user to easily recognize a method for mastering a job capability insufficient in aiming at a job level higher than his/her current job level.

The capability evaluation display unit 244 of the information providing device 100 according to the second example embodiment is configured in such a way as to perform processing for displaying an insufficient job capability in an order according to a frequency at which the insufficient job capability appears in high-level job offer information, as illustrated in FIG. 9. Thus, the user can easily recognize how many pieces of high-level job offer information represent a job capability insufficient in aiming at a job level higher than his/her current job level. In other words, the user can easily recognize how many pieces of high-level job offer information require his/her insufficient job capability. Therefore, the user can enhance motivation of self-improvement, such as which job capability to master.

The effect amount calculation unit 250 of the information providing device 100 according to the second example embodiment is configured in such a way as to calculate an effect amount being associated with an increase amount of a job value of the user supposing that each insufficient job capability is mastered. Then, the capability evaluation display unit 244 is configured in such a way as to perform processing for displaying an insufficient job capability in an order according to an effect amount. The user can easily recognize which insufficient job capability to master among job capabilities insufficient in aiming at a job level higher than his/her current job level, and how much effect may be gained accordingly. Therefore, motivation of self-improvement of the user can be enhanced.

### Third Example Embodiment

Next, a third example embodiment is described with reference to the drawings. For clarification of description, the following description and the drawings are suitably subjected to omission and simplification. Moreover, the same reference sign is assigned to the same element in each of the drawings, and repeated description thereof is omitted according to need. Note that, since a system configuration according to the third example embodiment is substantially similar to that illustrated in FIG. 2, description thereof is omitted.

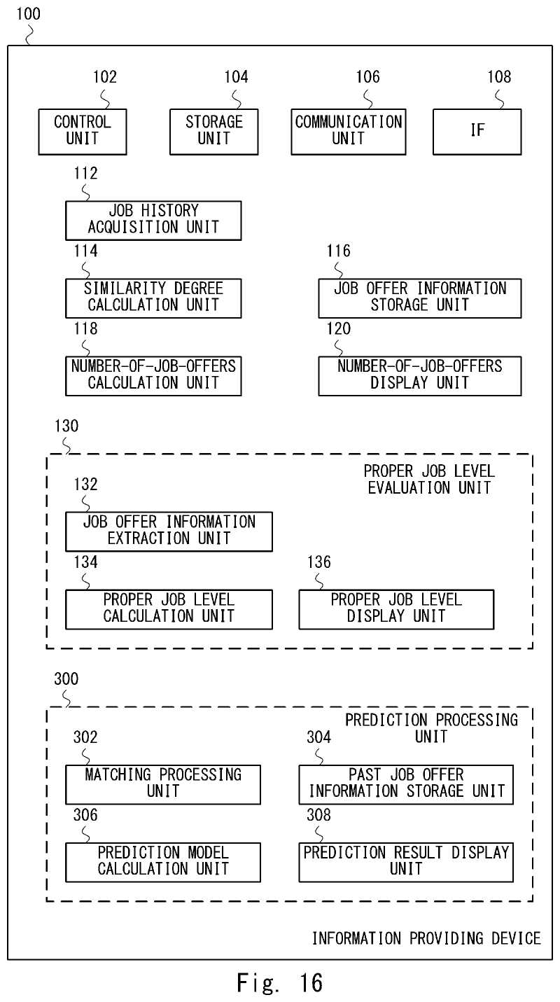

FIG. 16 is a diagram illustrating a configuration of an information providing device 100 according to the third example embodiment. Since a hardware configuration of the information providing device 100 according to the third example embodiment is substantially similar to that according to the first example embodiment, description thereof is omitted.

The information providing device 100 according to the third example embodiment includes a job history acquisition unit 112, a similarity degree calculation unit 114, a job offer information storage unit 116, a number-of-job-offers calculation unit 118, a number-of-job-offers display unit 120, and a proper job level evaluation unit 130. The information providing device 100 according to the third example embodiment further includes a prediction processing unit 300. The proper job level evaluation unit 130 includes a job offer information extraction unit 132, a proper job level calculation unit 134, and a proper job level display unit 136. The prediction processing unit 300 includes a matching processing unit 302, a past job offer information storage unit 304, a prediction model calculation unit 306, and a prediction result display unit 308.

The prediction processing unit 300 functions as a prediction processing means. The matching processing unit 302, the past job offer information storage unit 304, the prediction model calculation unit 306, and the prediction result display unit 308 function as a matching processing means, a past job offer information storage means, a prediction model calculation means, and a prediction result display means, respectively. Unless otherwise stated, functions of other components are substantially similar to those according to the first example embodiment.

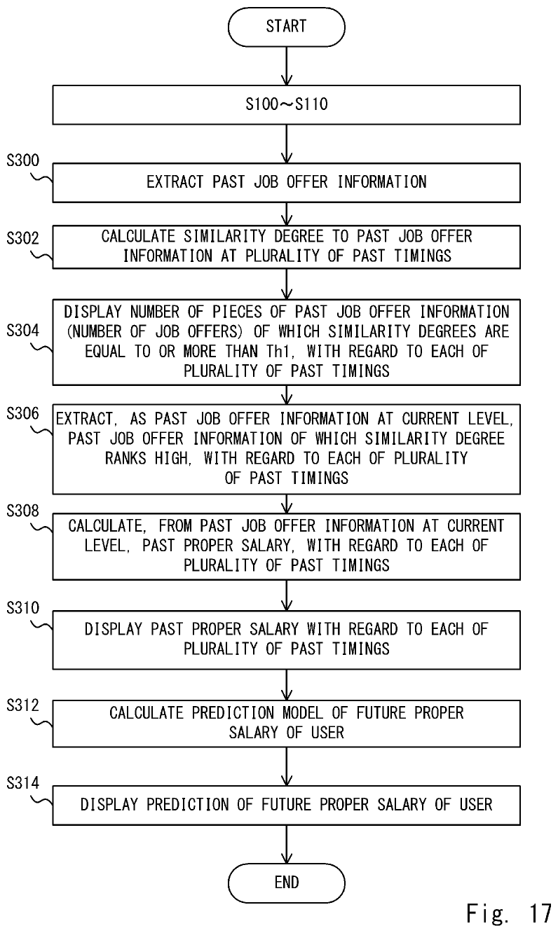

The prediction processing unit 300 performs processing for predicting a future job value of a user. The past job offer information storage unit 304 stores a plurality of pieces of job offer information of the past (past job offer information). In this instance, the past job offer information storage unit 304 stores pieces of the past job offer information together with time information indicating a time being associated with the job offer information. The matching processing unit 302 controls in such a way that processing similar to S102 to S110 is executed by use of the past job offer information and current job history information of the user. Other components are described later by use of FIG. 17.

FIG. 17 is a flowchart illustrating an information providing method executed by the information providing device 100 according to the third example embodiment. First, the information providing device 100 performs processing in S100 to S110 illustrated in FIG. 4. The matching processing unit 302 extracts a plurality of pieces of past job offer information stored in the past job offer information storage unit 304 (step S300). In other words, the matching processing unit 302 extracts, from the past job offer information storage unit 304, each of a plurality of pieces of past job offer information at each of specific timings (one year ago, two years ago, and the like). The matching processing unit 302 controls the similarity degree calculation unit 114, the number-of-job-offers calculation unit 118, the number-of-job-offers display unit 120, and the proper job level evaluation unit 130 in such a way that processing similar to S102 to S110 is executed by use of the past job offer information and current job history information of the user. Thus, processing in S302 to S310 described later is executed.

The similarity degree calculation unit 114 further calculates a similarity degree between the current job history information of the user and each of a plurality of pieces of past job offer information at each of a plurality of past timings, by a method similar to the processing in S102 (step S302). For example, the similarity degree calculation unit 114 calculates a similarity degree between the current job history information of the user and each of a plurality of pieces of past job offer information one year ago. Moreover, for example, the similarity degree calculation unit 114 calculates a similarity degree between the current job history information of the user and each of a plurality of pieces of past job offer information two years ago. Moreover, for example, the similarity degree calculation unit 114 calculates a similarity degree between the current job history information of the user and each of a plurality of pieces of past job offer information three years ago. Similarly, the similarity degree calculation unit 114 calculates a similarity degree between the current job history information of the user and each of a plurality of pieces of past job offer information M (M is an integer) years ago. Then, processing in S304 to S310 described later is executed with regard to each of a plurality of past timings (one year ago, two years ago, three years ago, . . . , and M years ago).

The number-of-job-offers display unit 120 performs processing in such a way as to display, as the number of job offers, the number of pieces of past job offer information of which similarity degrees are equal to or more than a predetermined threshold value Th1, with regard to each of a plurality of past timings by a method similar to the processing in S104 (step S304). Specifically, the number-of-job-offers calculation unit 118 calculates, as the number of job offers, the number of pieces of past job offer information of which similarity degrees calculated by the processing in step S302 are equal to or more than the threshold value Th1, with regard to each of a plurality of past timings. Then, the number-of-job-offers display unit 120 performs processing for displaying the number of job offers at each of a plurality of past timings on a user interface of a user terminal 20, by controlling the communication unit 106. Consequently, the number of job offers hit when matching processing is performed between current job history information of the user and past job offer information at each of a plurality of past timings is displayed.

For example, the number of job offers hit when matching processing is performed between current job history information of the user and past job offer information one year ago is displayed. Moreover, for example, the number of job offers hit when matching processing is performed between current job history information of the user and past job offer information two year ago is displayed. Moreover, for example, the number of job offers hit when matching processing is performed between current job history information of the user and past job offer information three year ago is displayed. Similarly, the number of job offers hit when matching processing is performed between current job history information of the user and past job offer information M years ago is displayed. Consequently, the user can easily recognize what number of job offers there have been with his/her current job history information.

The job offer information extraction unit 132 further extracts, as past job offer information at a current level, past job offer information of which a similarity degree ranks high, with regard to each of a plurality of past timings, by a method similar to the processing in S106 (step S306). In other words, the job offer information extraction unit 132 extracts past job offer information at a current level (first job offer information) being job offer information of which a similarity degree is equal to or more than a predetermined criterion (first criterion), with regard to each of a plurality of past timings. Specifically, the job offer information extraction unit 132 extracts, as past job offer information at a current level, past job offer information of which a similarity degree ranks high, among pieces of the past job offer information hit by the processing in S304, with regard to each of a plurality of past timings. For example, the job offer information extraction unit 132 may extract, as past job offer information at a current level, past job offer information of which a similarity degree is equal to or more than a predetermined threshold value Th2 (>Th1). Alternatively, the job offer information extraction unit 132 may extract, as past job offer information at a current level, A% of the past job offer information of which a similarity degree ranks high, among pieces of the past job offer information hit by the processing in S304. Note that the above-described threshold value Th2 and A(%) are each associated with the predetermined criterion (first criterion).

The proper job level calculation unit 134 further calculates, from the extracted past job offer information at a current level, a past proper salary for the current job history information of the user, by a method similar to the processing in S108, with regard to each of a plurality of past timings (step S308). In other words, the proper job level calculation unit 134 calculates a proper job level at each of a plurality of past timings, by use of the past job offer information at a current level extracted by the processing in S306. Specifically, the proper job level calculation unit 134 extracts a salary in a content of recruitment indicated in each of the extracted pieces of current-level job offer information with regard to each of a plurality of past timings. Then, the proper job level calculation unit 134 calculates an average value of the extracted salaries, and determines the average value as a proper salary at each of a plurality of past timings.

The proper job level display unit 136 performs processing for displaying the past proper salary for the current job history information of the user calculated by the processing in S308, by a method similar to the processing in S110, with regard to each of a plurality of past timings (step S310). In other words, the proper job level display unit 136 performs processing for displaying the calculated proper job level at each of a plurality of past timings. Specifically, the proper job level display unit 136 performs processing for displaying a past proper salary on the user interface of the user terminal 20, by controlling the communication unit 106. Consequently, the past proper salary for the current job history information of the user is displayed on the user interface of the user terminal 20.

For example, a proper salary one year ago for the current job history information of the user is displayed. Moreover, for example, a proper salary two years ago for the current job history information of the user is displayed. Moreover, for example, a proper salary three years ago for the current job history information of the user is displayed. Similarly, a proper salary M years ago for the current job history information of the user is displayed. Consequently, the user can easily recognize his/her past proper salary for the current job history information of the user.

The prediction model calculation unit 306 calculates a prediction model of a future proper salary of the user from the past proper salary calculated in step S308 (step S312). The prediction result display unit 308 displays a prediction of a future proper salary of the user (step S314). In other words, the prediction processing unit 300 performs processing for predicting a future proper salary of the user, based on a proper job level at each of a plurality of past timings, and displaying a prediction result.

Specifically, the prediction model calculation unit 306 acquires a data group represented by a plurality of current and past timings and a proper salary being associated with each of the timings, calculated in S108 and S308, respectively. The data group is represented as, for example, (currently, five million yen), (one year ago, six million yen), (two years ago, seven million yen), or the like. The prediction model calculation unit 306 calculates an equation (function) of an approximated curve of the data group as a prediction model of a future proper salary of the user. The equation of the approximated curve is calculated by, for example, a least squares method or the like.

The prediction result display unit 308 performs control in such a way as to display the prediction model (approximated curve) in a graphical form. Then, the prediction result display unit 308 performs processing for displaying a prediction value of a proper salary Y years later, by use of the prediction model (approximated curve). The prediction result display unit 308 performs processing for displaying a prediction result on the user interface of the user terminal 20, by controlling the communication unit 106. Consequently, the prediction result is displayed on the user interface of the user terminal 20.

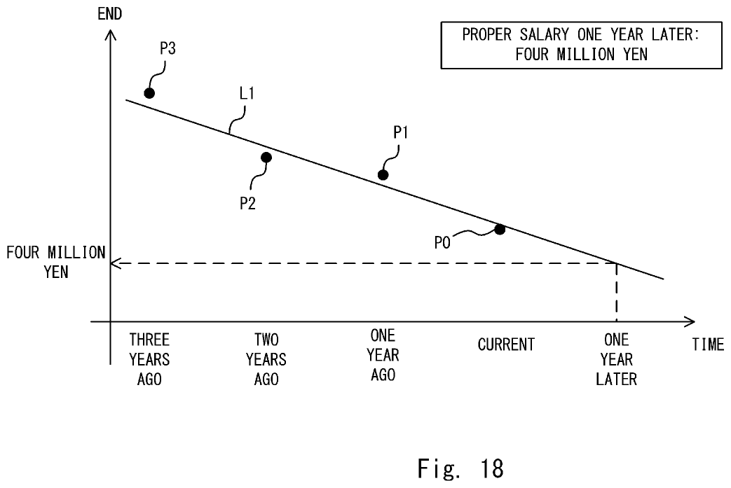

FIG. 18 is a diagram exemplifying a prediction result displayed by the prediction result display unit 308 according to the third example embodiment. A prediction result illustrated in FIG. 18 is represented in a graphical form in which a horizontal axis indicates time, and a vertical axis indicates a proper salary. In the example of FIG. 18, data P0, P1, P2, and P3 on current, one-year-ago, two-years-ago, and three-years-ago proper salaries are represented. Further, an approximated curve L1 of the P0, P1, P2, and P3 is represented. Then, a prediction result indicating that proper salary one year later is four million yen is displayed by use of the approximated curve L1.

Thus, the information providing device 100 according to the third example embodiment is configured in such a way as to perform processing for predicting a future proper job level (proper salary) of the user, based on a proper job level at each of a plurality of past timings, and displaying a prediction result. Consequently, the user can easily recognize a prediction of his/her future proper job level. Therefore, motivation of self-improvement of the user can be enhanced particularly in such a case that a proper salary drops with elapse of time, as in the example of FIG. 18.

Note that the prediction processing unit 300 may perform a prediction of the number of future job offers for the current job history information of the user, from the number of past job offers for the current job history information of the user calculated in S304, as in the processing in S312. Then, the prediction processing unit 300 may perform processing for displaying a prediction result of the number of job offers, as in the processing in S314. Consequently, the user can easily recognize a prediction of the number of future job offers for the current job history information. Therefore, motivation of self-improvement of the user can be enhanced particularly in such a case that the number of job offers decreases with elapse of time.

### Fourth Example Embodiment

Next, a fourth example embodiment is described with reference to the drawings. For clarification of description, the following description and the drawings are suitably subjected to omission and simplification. Moreover, the same reference sign is assigned to the same element in each of the drawings, and repeated description thereof is omitted according to need. Note that, since a system configuration according to the fourth example embodiment is substantially similar to that illustrated in FIG. 2, description thereof is omitted.

FIG. 14 is a diagram illustrating a configuration of an information providing device 100 according to the fourth example embodiment. Since a hardware configuration of the information providing device 100 according to the fourth example embodiment is substantially similar to that according to the first example embodiment, description thereof is omitted.

The information providing device 100 according to the fourth example embodiment includes a job history acquisition unit 112, a similarity degree calculation unit 114, a job offer information storage unit 116, a number-of-job-offers calculation unit 118, a number-of-job-offers display unit 120, and a proper job level evaluation unit 130. The information providing device 100 according to the fourth example embodiment further includes a growth degree evaluation unit 400. The proper job level evaluation unit 130 includes a job offer information extraction unit 132, a proper job level calculation unit 134, and a proper job level display unit 136. The growth degree evaluation unit 400 includes a matching processing unit 402, a past job history storage unit 404, a growth degree calculation unit 406, and a growth degree display unit 408.

The growth degree evaluation unit 400 functions as a growth degree evaluation means. The matching processing unit 402, the past job history storage unit 404, the growth degree calculation unit 406, and the growth degree display unit 408 function as a matching processing means, a past job history storage means, a growth degree calculation means, and a growth degree display unit means, respectively. Unless otherwise stated, functions of other components are substantially similar to those according to the first example embodiment.

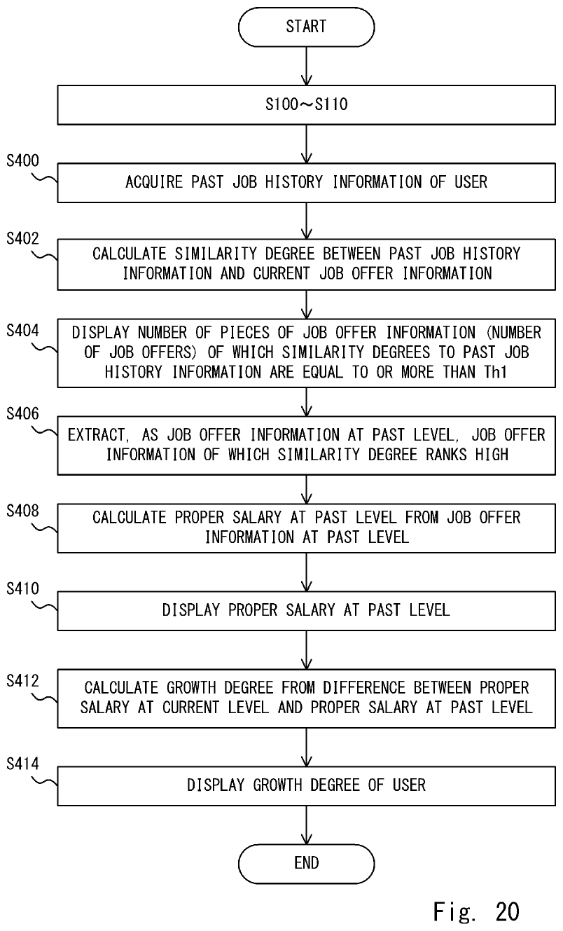

The growth degree evaluation unit 400 performs processing for evaluating a growth degree of a user. The past job history storage unit 404 stores job history information of the past (past job history information) of the user. In this instance, the past job history storage unit 404 may store the past job history information together with time information indicating a time being associated with the past job history information. The matching processing unit 402 performs control in such a way that processing similar to S102 to S110 is executed by use of the past job history information of the user and current job offer information. The growth degree calculation unit 406 calculates a growth degree of the user. The growth degree display unit 408 performs processing for displaying a growth degree. Details are described later by use of FIG. 20.

FIG. 20 is a flowchart illustrating an information providing method executed by the information providing device 100 according to the fourth example embodiment. First, the information providing device 100 performs processing in S100 to S110 illustrated in FIG. 4. The matching processing unit 402 controls the job history acquisition unit 112 in such a way as to acquire past job history information of the user from the past job history storage unit 404. Thus, the job history acquisition unit 112 further acquires the past job history information (step S400).

The matching processing unit 402 controls the similarity degree calculation unit 114, the number-of-job-offers calculation unit 118, the number-of-job-offers display unit 120, and the proper job level evaluation unit 130 in such a way that processing similar to S102 to S110 is executed by use of current job offer information and past job history information. Thus, processing in S402 to S410 described later is executed. Note that the matching processing unit 402 may control the job history acquisition unit 112 in such a way as to acquire past job history information at each of a plurality of past timings from the past job history storage unit 404. In this case, processing in S402 to S414 illustrated below is executable with regard to each of a plurality of past timings.

The similarity degree calculation unit 114 further calculates a similarity degree between the past job history information of the user and each of a plurality of job offer information, by a method similar to the processing in S102 (step S402). For example, the similarity degree calculation unit 114 calculates a similarity degree between past job history information of the user one year ago and each of a plurality of job offer information.

The number-of-job-offers display unit 120 performs processing in such a way as to display, as the number of job offers, the number of pieces of past job offer information of which similarity degrees to the past job history information are equal to or more than a predetermined threshold value Th1, by a method similar to the processing in S104 (step S404). Specifically, the number-of-job-offers calculation unit 118 calculates, as the number of job offers, the number of pieces of job offer information of which similarity degrees calculated by the processing in step S402 are equal to or more than the threshold value Th1. Then, the number-of-job-offers display unit 120 performs processing for displaying the number of job offers on a user interface of a user terminal 20, by controlling the communication unit 106. Consequently, the number of job offers hit when matching processing is performed between past job history information of the user and a plurality of pieces of job offer information is displayed. Thus, the user can easily recognize what number of job offers there are currently with his/her past job history information.

The job offer information extraction unit 132 extracts, as job offer information at a past level (past-level job offer information), the job offer information of which a similarity degree to the past job history information ranks high, by a method similar to the processing in S106 (step S406). In other words, the job offer information extraction unit 132 extracts job offer information at a past level (first job offer information) of which a similarity degree regarding the past job history information is equal to or more than a predetermined criterion (first criterion). Specifically, the job offer information extraction unit 132 extracts, as past-level job offer information, the job offer information of which a similarity degree ranks high, among pieces of the job offer information hit by the processing in S404 for the past job history information. For example, the job offer information extraction unit 132 may extract, as past-level job offer information, the job offer information of which a similarity degree is equal to or more than a predetermined threshold value Th2 (>Th1). Alternatively, the job offer information extraction unit 132 may extract, as past-level job offer information, A% of the job offer information of which a similarity degree ranks high, among pieces of the job offer information hit by the processing in S404. Note that the above-described threshold value Th2 and A(%) are each associated with the predetermined criterion (first criterion).

The proper job level calculation unit 134 calculates a proper salary at a past level for past job history information of the user from the past-level job offer information extracted by the processing in S406, by a method similar to the processing in S108 (step S408). In other words, the proper job level calculation unit 134 calculates a proper job level of the past of the user, by use of the job offer information extracted with regard to the past job history information. Specifically, the proper job level calculation unit 134 extracts a salary in a content of recruitment indicated in each of pieces of the past-level job offer information extracted for the past job history information. Then, the proper job level calculation unit 134 calculates an average value of the extracted salaries, and determines the average value as a proper salary of the user at a past level.

The proper job level display unit 136 performs processing for displaying the proper salary at a past level for the past job history information of the user calculated by the processing in S408, by a method similar to the processing in S110 (step S410). In other words, the proper job level display unit 136 performs processing for displaying the calculated proper job level at a past level. Specifically, the proper job level display unit 136 performs processing for displaying a proper salary at a past level on the user interface of the user terminal 20, by controlling the communication unit 106. Thus, the proper salary at a past level for the past job history information of the user is displayed on the user interface of the user terminal 20. Consequently, the user can easily recognize a proper salary for his/her past job history information.

The growth degree calculation unit 406 calculates a growth degree according to a difference between a proper salary at a current level and a proper salary at a past level (step S412). In other words, the growth degree calculation unit 406 calculates a growth degree of the user, based on a difference between a current proper job level and a past proper job level of the user. Specifically, the growth degree calculation unit 406 calculates a difference (proper salary difference ΔP) between the proper salary at current level and proper salary at a past level. The growth degree calculation unit 406 may calculate, as a growth degree, a proper salary increase degree E (ΔP/ΔT) being a value acquired by dividing the proper salary difference ΔP by a time difference ΔT between a time relating to past job history information and a current time, for example. Alternatively, the growth degree calculation unit 406 may calculate a rank of a growth degree being associated with the proper salary difference ΔP, by use of a previously stored table associating the proper salary difference ΔP with a rank. For example, a growth degree may be determined as a “growth degree 5” when the ΔP is one million yen or more, may be determined as a “growth degree 4” when the ΔP is less than one million yen and five hundred thousand yen or less, and may be determined as a “growth degree 3” when the ΔP is less than five hundred thousand yen. Alternatively, the growth degree calculation unit 406 may calculate the proper salary difference ΔP itself as a growth degree.

The growth degree display unit 408 performs processing for displaying the growth degree of the user calculated by the processing in S412 (step S414). The growth degree display unit 408 performs processing for displaying the growth degree on the user interface of the user terminal 20, by controlling the communication unit 106. Consequently, the growth degree is displayed on the user interface of the user terminal 20. Note that, when the above-described processing is performed with regard to past job history information at each of a plurality of past timings (one year ago, two years ago, . . . , and M years ago), the growth degree display unit 408 may display transition of a growth degree.

Thus, the information providing device 100 according to the fourth example embodiment is configured in such a way as to display a growth degree. Consequently, the user can easily recognize his/her growth degree. Therefore, the user can enhance motivation of self-improvement.

### Modification Example

Note that the present invention is not limited to the above-described example embodiments, and is suitably changeable without departing from the spirit thereof. For example, a plurality of the above-described example embodiments are mutually applicable. For example, the configuration according to the second example embodiment may be combined with the first example embodiment. The same also applies to the other example embodiments.

Furthermore, in each of the above-described flowcharts, an order of each piece of processing (step) is suitably changeable. Moreover, one or more of a plurality of pieces of processing (steps) may be omitted. For example, S112 to S114 in FIG. 4 may be executed before the processing in S108. Moreover, in FIGS. 4, S104 and S112 to S114 may be absent.

Furthermore, although a case where a job level is a salary is described in each of the above-described example embodiments, a job level may be treatment other than a salary. For example, a job level may be a post. In this case, for example, in the first example embodiment, the proper job level calculation unit 134 calculates a current proper post of the user from the current-level job offer information extracted by the processing in S106 (step S108). Specifically, the proper job level calculation unit 134 extracts a post in a content of recruitment indicated in each of the extracted pieces of current-level job offer information. Herein, it is assumed that a predetermined numerical value rank is allocated for each level (an assistant manager, a manager, a general manager, or the like) of a post. The proper job level calculation unit 134 calculates an average value of the extracted numerical value ranks, and determines, as a proper post, a post being associated with the average value.

Furthermore, when a job level is a post, the high-level job offer extraction unit 232 ranks, by similarity degrees, job offer information indicating a post higher by X ranks (X is a predetermined value) than a current proper post calculated in S108 (step S202), in the second example embodiment. The high-level job offer extraction unit 232 limits to job offer information indicating a post higher by X ranks than a current proper post calculated in S108, and re-ranks the limited job offer information by similarity degrees. Then, the high-level job offer extraction unit 232 extracts, as job offer information at a high level (high-level job offer information), job offer information of which a similarity degree ranks high, among pieces of the re-ranked job offer information. The same also applies to the other example embodiments.

Furthermore, although job offer information is a job offer advertisement formed by an enterprise in each of the above-described example embodiments, such a configuration is not a limitation. Job offer information may be information relating to in-house human resource recruitment, or may be information relating to in-house job description. Moreover, similarly, job history information is not limited to job history information used in job seeking for an enterprise, and also includes history information for an in-house purpose. Further, job offer information may include job history information of another user. Job history information of another user transmitted to (registered in) the system according to the present disclosure indicates a salary, a post, and a job capability of a user or the like seeking for a job, and can be said to reflect market prices of a salary, a post, and a job capability of a job seeker for a job offer. Particularly, a salary, a post, and a job capability of a user whose job transfer to/job finding at an enterprise or the like has been decided can be associated with a content of a job offer advertisement of the enterprise. Therefore, job history information of another user is capable of being included in job offer information.

Furthermore, although it is assumed that a proper job level and the like illustrated in FIGS. 5 to 11 and the like are displayed on the user terminal 20 in each of the above-described example embodiments, such a configuration is not a limitation. A proper job level and the like may be displayed on the interface unit 108 of the information providing device 100. Therefore, a device with which a user inputs job history information and a device that displays a proper job level and the like may differ from each other.

In each of the above-described examples, a program can be stored by use of various types of non-transitory computer-readable media, and supplied to a computer. The non-transitory computer-readable media include various types of tangible storage media. Examples of the non-transitory computer-readable media include a magnetic recording medium (e.g., a flexible disk, a magnetic tape, and a hard disk drive), a magneto-optical recording medium (e.g., a magneto-optical disk), a CD-read only memory (CD-ROM), a CD-R, a CD-R/W, a semiconductor memory (e.g., a mask ROM, a programmable ROM (PROM), an erasable PROM (EPROM), a flash ROM, and a random access memory (RAM)). Moreover, the program may be supplied to a computer by various types of transitory computer readable media. Examples of the transitory computer readable media include an electric signal, an optical signal, and an electromagnetic wave. The transitory computer readable medium can supply the program to a computer via a wired communication path such as an electric wire or an optical fiber, or a wireless communication path.

Some or all of the above-described example embodiments can be described as, but not limited to, the following supplementary notes.

### Supplementary Note 1

An information providing device including:

a job history acquisition means for acquiring job history information indicating a job history of a user;

a similarity degree calculation means for calculating a similarity degree between the job history information and each of a plurality of pieces of job offer information;

a first extraction means for extracting the job offer information of which the similarity degree is equal to or more than a predetermined criterion;

a proper job level calculation means for calculating a proper job level of the user by use of the extracted job offer information; and

a proper job level display means for performing processing for displaying the calculated proper job level.

### Supplementary Note 2

The information providing device according to Supplementary note 1, further including:

a second extraction means for extracting high-level job offer information being the job offer information of which a similarity degree between the job history information and a plurality of pieces of the job offer information indicating job levels being equal to or more than a predetermined criterion for the proper job level is equal to or more than a predetermined criterion;

a capability determination means for determining an insufficient job capability being a job capability insufficient for the user for the high-level job offer information, based on a difference between a job capability of the user indicated in the job history information and a job capability indicated in the high-level job offer information; and

a capability evaluation display means for performing processing for displaying the insufficient job capability.

### Supplementary Note 3

The information providing device according to Supplementary note 2, wherein the capability evaluation display means performs processing for displaying the insufficient job capability in an order according to a difficulty level of mastering the insufficient job capability.

### Supplementary Note 4

The information providing device according to Supplementary note 2, wherein the capability evaluation display means performs processing for displaying the insufficient job capability in an order according to a frequency at which the insufficient job capability appears in the high-level job offer information.

### Supplementary Note 5

The information providing device according to Supplementary note 2, further including an effect amount calculation means for calculating an effect amount being associated with an increase amount of a job value of the user supposing that each of the insufficient job capabilities is mastered, wherein

the job value is associated with at least one of the job level and the number of pieces of the job offer information of which the similarity degrees are equal to or more than a predetermined threshold value, and

the capability evaluation display means performs processing for displaying the insufficient job capability in an order according to the effect amount.

### Supplementary Note 6

The information providing device according to any one of Supplementary notes 2 to 5, wherein the capability evaluation display means performs processing for displaying information indicating a method for mastering the insufficient job capability.

### Supplementary Note 7

The information providing device according to Supplementary note 1, further including a prediction processing means for performing processing for predicting a future proper job level of the user, wherein

the similarity degree calculation means further calculates a similarity degree between the job history information and each of a plurality of pieces of job offer information at each of a plurality of past timings,

the first extraction means further extracts the job offer information of which the similarity degree to the job offer information is equal to or more than a predetermined criterion with regard to each of a plurality of the past timings,

the proper job level calculation means further calculates a proper job level at each of a plurality of the past timings, by use of the job offer information extracted with regard to each of a plurality of the past timings, and

the prediction processing means performs processing for predicting a future job level of the user, based on a current proper job level and a proper job level at each of a plurality of the past timings, and displaying a prediction result.

### Supplementary Note 8

The information providing device according to Supplementary note 1, further including:

a growth degree calculation means for calculating a growth degree of the user; and

a growth degree display means for performing processing for displaying the growth degree, wherein

the job history acquisition means further acquires past job history information of the user,

the similarity degree calculation means further calculates a similarity degree between the past job history information and each of a plurality of pieces of job offer information,

the first extraction means further extracts the job offer information of which the similarity degree regarding the past job history information is equal to or more than a predetermined criterion,

the proper job level calculation means further calculates a past proper job level of the user, by use of the job offer information extracted with regard to the past job history information, and

the growth degree calculation means calculates a growth degree of the user, based on a difference between a current proper job level and a past proper job level of the user.

### Supplementary Note 9

An information providing system including:

a user terminal configured to accept job history information indicating a job history of a user; and

an information providing device configured to provide information relating to a job of the user, wherein the information providing device includes

a job history acquisition means for acquiring the job history information from the user terminal,

a similarity degree calculation means for calculating a similarity degree between the job history information and each of a plurality of pieces of job offer information,

a first extraction means for extracting the job offer information of which the similarity degree is equal to or more than a predetermined criterion,

a proper job level calculation means for calculating a proper job level of the user by use of the extracted job offer information, and

a proper job level display means for performing processing for displaying the calculated proper job level on the user terminal.

### Supplementary Note 10

The information providing system according to Supplementary note 9, wherein the information providing device further includes:

a second extraction means for extracting high-level job offer information being the job offer information of which a similarity degree between the job history information and a plurality of pieces of the job offer information indicating job levels being equal to or more than a predetermined criterion for the proper job level is equal to or more than a predetermined criterion;

a capability determination means for determining an insufficient job capability being a job capability insufficient for the user for the high-level job offer information, based on a difference between a job capability of the user indicated in the job history information and a job capability indicated in the high-level job offer information; and

a capability evaluation display means for performing processing for displaying the insufficient job capability on the user terminal.

### Supplementary Note 11

The information providing system according to Supplementary note 10, wherein the capability evaluation display means performs processing for displaying the insufficient job capability in an order according to a difficulty level of mastering the insufficient job capability.

### Supplementary Note 12

The information providing system according to Supplementary note 10, wherein the capability evaluation display means performs processing for displaying the insufficient job capability in an order according to a frequency at which the insufficient job capability appears in the high-level job offer information.

### Supplementary Note 13

The information providing system according to Supplementary note 10, wherein

the information providing device further includes an effect amount calculation means for calculating an effect amount being associated with an increase amount of a job value of the user supposing that each of the insufficient job capabilities is mastered,

the job value is associated with at least one of the job level and the number of pieces of the job offer information of which the similarity degrees are equal to or more than a predetermined threshold value, and

the capability evaluation display means performs processing for displaying the insufficient job capability in an order according to the effect amount.

### Supplementary Note 14

The information providing system according to any one of Supplementary notes 10 to 13, wherein the capability evaluation display means performs processing for displaying information indicating a method for mastering the insufficient job capability.

### Supplementary Note 15

The information providing system according to Supplementary note 9, wherein

the information providing device further includes a prediction processing means for performing processing for predicting a future proper job level of the user,

the similarity degree calculation means further calculates a similarity degree between the job history information and each of a plurality of pieces of job offer information at each of a plurality of past timings,

the first extraction means further extracts the job offer information of which the similarity degree to the job offer information is equal to or more than a predetermined criterion with regard to each of a plurality of the past timings,

the proper job level calculation means further calculates a proper job level at each of a plurality of the past timings, by use of the job offer information extracted with regard to each of a plurality of the past timings, and

the prediction processing means performs processing for predicting a future job level of the user, based on a current proper job level and a proper job level at each of a plurality of the past timings, and displaying a prediction result.

### Supplementary Note 16

The information providing system according to Supplementary note 9, wherein the information providing device further includes

a growth degree calculation means for calculating a growth degree of the user, and

a growth degree display means for performing processing for displaying the growth degree,

the job history acquisition means further acquires past job history information of the user,

the similarity degree calculation means further calculates a similarity degree between the past job history information and each of a plurality of pieces of job offer information,

the first extraction means further extracts the job offer information of which the similarity degree regarding the past job history information is equal to or more than a predetermined criterion,

the proper job level calculation means further calculates a past proper job level of the user, by use of the job offer information extracted with regard to the past job history information, and

the growth degree calculation means calculates a growth degree of the user, based on a difference between a current proper job level and a past proper job level of the user.

### Supplementary Note 17

An information providing method including:

acquiring job history information indicating a job history of a user;

calculating a similarity degree between the job history information and each of a plurality of pieces of job offer information;

extracting the job offer information of which the similarity degree is equal to or more than a predetermined criterion;

calculating a proper job level of the user by use of the extracted job offer information; and

performing processing for displaying the calculated proper job level.

### Supplementary Note 18

The information providing method according to Supplementary note 17, further including:

extracting high-level job offer information being the job offer information of which a similarity degree between the job history information and a plurality of pieces of the job offer information indicating job levels being equal to or more than a predetermined criterion for the proper job level is equal to or more than a predetermined criterion;

determining an insufficient job capability being a job capability insufficient for the user for the high-level job offer information, based on a difference between a job capability of the user indicated in the job history information and a job capability indicated in the high-level job offer information; and

performing processing for displaying the insufficient job capability.

### Supplementary Note 19

The information providing method according to Supplementary note 18, further including performing processing for displaying the insufficient job capability in an order according to a difficulty level of mastering the insufficient job capability.

### Supplementary Note 20

The information providing method according to Supplementary note 18, further including performing processing for displaying the insufficient job capability in an order according to a frequency at which the insufficient job capability appears in the high-level job offer information.

### Supplementary Note 21

The information providing method according to Supplementary note 18, further including:

calculating an effect amount being associated with an increase amount of a job value of the user supposing that each of the insufficient job capabilities is mastered;

causing the job value to be associated with at least one of the job level and the number of pieces of the job offer information of which the similarity degrees are equal to or more than a predetermined threshold value; and

performing processing for displaying the insufficient job capability in an order according to the effect amount.

### Supplementary Note 22

The information providing method according to any one of Supplementary notes 18 to 21, further including performing processing for displaying information indicating a method for mastering the insufficient job capability.

### Supplementary Note 23

The information providing method according to Supplementary note 17, further including:

further calculating a similarity degree between the job history information and each of a plurality of pieces of job offer information at each of a plurality of past timings;

further extracting the job offer information of which the similarity degree to the job offer information is equal to or more than a predetermined criterion with regard to each of a plurality of the past timings;

further calculating a proper job level at each of a plurality of the past timings, by use of the job offer information extracted with regard to each of a plurality of the past timings; and

performing processing for predicting a future job level of the user, based on a current proper job level and a proper job level at each of a plurality of the past timings, and displaying a prediction result.

### Supplementary Note 24

The information providing method according to Supplementary note 17, further including:

further acquiring past job history information of the user;

further calculating a similarity degree between the past job history information and each of a plurality of pieces of job offer information;

further extracting the job offer information of which the similarity degree regarding the past job history information is equal to or more than a predetermined criterion;

further calculating a past proper job level of the user, by use of the job offer information extracted with regard to the past job history information;

calculating a growth degree of the user, based on a difference between a current proper job level and a past proper job level of the user; and

performing processing for displaying the growth degree.

### Supplementary Note 25

A non-transitory computer-readable medium storing a program that causes a computer to achieve:

a function of acquiring job history information indicating a job history of a user;

a function of calculating a similarity degree between the job history information and each of a plurality of pieces of job offer information;

a function of extracting the job offer information of which the similarity degree is equal to or more than a predetermined criterion;

a function of calculating a proper job level of the user by use of the extracted job offer information; and

a function of performing processing for displaying the calculated proper job level.

While the invention of the present application has been described above with reference to the example embodiments, the invention of the present application is not limited by the above description. Various changes that may be understood by a person skilled in the art can be made to a configuration and details of the invention of the present application within the scope of the invention.

This application is based upon and claims the benefit of priority from Japanese Patent Application No. 2019-006043, filed on Jan. 17, 2019, the disclosure of which is incorporated herein in its entirety by reference.

### REFERENCE SIGNS LIST

1 Information providing system
10 Information providing device
11 Job history acquisition unit
12 Similarity degree calculation unit
13 Job offer information extraction unit
14 Proper job level calculation unit
15 Proper job level display unit
20 User terminal
100 Information providing device
112 Job history acquisition unit
114 Similarity degree calculation unit
116 Job offer information storage unit
118 Number-of-job-offers calculation unit
120 Number-of-job-offers display unit
130 Proper job level evaluation unit
132 Job offer information extraction unit
134 Proper job level calculation unit
136 Proper job level display unit
140 Current level capability evaluation unit
142 Capability determination unit
144 Capability evaluation display unit
146 Mastering difficulty level storage unit
150 Effect amount calculation unit
230 High-level job offer processing unit
232 High-level job offer extraction unit
240 Future-level capability evaluation unit
242 Capability determination unit
244 Capability evaluation display unit
246 Mastering difficulty level storage unit
250 Effect amount calculation unit
300 Prediction processing unit
302 Matching processing unit
304 Past job offer information storage unit
306 Prediction model calculation unit
308 Prediction result display unit
400 Growth degree evaluation unit
402 Matching processing unit
404 Past job history storage unit
406 Growth degree calculation unit
408 Growth degree display unit

What is claimed is:

1. An information providing device comprising:
hardware, including a processor and memory;
job history acquisition unit implemented at least by the hardware and configured to acquire job history information indicating a job history of a user;
similarity degree calculation moans for calculating unit implemented at least by the hardware and configured to calculate a similarity degree between the job history information and each of a plurality of pieces of job offer information;
first extraction unit implemented at least by the hardware and configured to extract the job offer information of which the similarity degree is equal to or more than a predetermined criterion;
proper job level calculation unit implemented at least by the hardware and configured to calculate a proper job level of the user by use of the extracted job offer information; and
proper job level display unit implemented at least by the hardware and configured to perform processing for displaying the calculated proper job level.

2. The information providing device according to claim 1, further comprising:
second extraction implemented at least by the hardware and configured to extract high-level job offer information being the job offer information of which a similarity degree between the job history information and a plurality of pieces of the job offer information indicating job levels being equal to or more than a predetermined criterion for the proper job level is equal to or more than a predetermined criterion;
capability determination unit implemented at least by the hardware and configured to determine an insufficient job capability being a job capability insufficient for the user for the high-level job offer information, based on a difference between a job capability of the user indicated in the job history information and a job capability indicated in the high-level job offer information; and
capability evaluation display unit implemented at least by the hardware and configured to perform processing for displaying the insufficient job capability.

3. The information providing device according to claim 2, wherein the capability evaluation display unit performs processing for displaying the insufficient job capability in an order according to a difficulty level of mastering the insufficient job capability.

4. The information providing device according to claim 2, wherein the capability evaluation display unit performs processing for displaying the insufficient job capability in an order according to a frequency at which the insufficient job capability appears in the high-level job offer information.

5. The information providing device according to claim 2, further comprising effect amount calculation unit implemented at least by the hardware and configured to calculate an effect amount being associated with an increase amount of a job value of the user supposing that each of the insufficient job capabilities is mastered, wherein
the job value is associated with at least one of the job level and the number of pieces of the job offer information of which the similarity degrees are equal to or more than a predetermined threshold value, and
the capability evaluation display unit performs processing for displaying the insufficient job capability in an order according to the effect amount.

6. The information providing device according to claim 2, wherein the capability evaluation display unit performs processing for displaying information indicating a method for mastering the insufficient job capability.

7. The information providing device according to claim 1, further comprising prediction processing unit implemented at least by the hardware and configured to perform processing for predicting a future proper job level of the user, wherein
the similarity degree calculation unit further calculates a similarity degree between the job history information and each of a plurality of pieces of job offer information at each of a plurality of past timings,
the first extraction unit further extracts the job offer information of which the similarity degree to the job offer information is equal to or more than a predetermined criterion with regard to each of a plurality of the past timings,
the proper job level calculation unit further calculates a proper job level at each of a plurality of the past timings, by use of the job offer information extracted with regard to each of a plurality of the past timings, and
the prediction processing unit performs processing for predicting a future job level of the user, based on a current proper job level and a proper job level at each of a plurality of the past timings, and displaying a prediction result.

8. The information providing device according to claim 1, further comprising:
growth degree calculation unit implemented at least by the hardware and configured to calculate a growth degree of the user; and
growth degree display unit implemented at least by the hardware and configured to perform processing for displaying the growth degree, wherein
the job history acquisition unit further acquires past job history information of the user,
the similarity degree calculation unit further calculates a similarity degree between the past job history information and each of a plurality of pieces of job offer information,
the first extraction unit further extracts the job offer information of which the similarity degree regarding the past job history information is equal to or more than a predetermined criterion,
the proper job level calculation unit further calculates a past proper job level of the user, by use of the job offer information extracted with regard to the past job history information, and
the growth degree calculation unit calculates a growth degree of the user, based on a difference between a current proper job level and a past proper job level of the user.

9-16. (canceled)

17. An information providing method comprising:
acquiring job history information indicating a job history of a user;
calculating a similarity degree between the job history information and each of a plurality of pieces of job offer information;
extracting the job offer information of which the similarity degree is equal to or more than a predetermined criterion;
calculating a proper job level of the user by use of the extracted job offer information; and
performing processing for displaying the calculated proper job level.

18. The information providing method according to claim 17, further comprising:
extracting high-level job offer information being the job offer information of which a similarity degree between the job history information and a plurality of pieces of the job offer information indicating job levels being equal to or more than a predetermined criterion for the proper job level is equal to or more than a predetermined criterion;
determining an insufficient job capability being a job capability insufficient for the user for the high-level job offer information, based on a difference between a job capability of the user indicated in the job history information and a job capability indicated in the high-level job offer information; and
performing processing for displaying the insufficient job capability.

19. The information providing method according to claim 18, further comprising performing processing for displaying the insufficient job capability in an order according to a difficulty level of mastering the insufficient job capability.

20. The information providing method according to claim 18, further comprising performing processing for displaying the insufficient job capability in an order according to a frequency at which the insufficient job capability appears in the high-level job offer information.

21. The information providing method according to claim 18, further comprising:
calculating an effect amount being associated with an increase amount of a job value of the user supposing that each of the insufficient job capabilities is mastered;
causing the job value to be associated with at least one of the job level and the number of pieces of the job offer information of which the similarity degrees are equal to or more than a predetermined threshold value; and
performing processing for displaying the insufficient job capability in an order according to the effect amount.

22. The information providing method according to claim 18, further comprising performing processing for displaying information indicating a method for mastering the insufficient job capability.

23. The information providing method according to claim 17, further comprising:
further calculating a similarity degree between the job history information and each of a plurality of pieces of job offer information at each of a plurality of past timings;
further extracting the job offer information of which the similarity degree to the job offer information is equal to or more than a predetermined criterion with regard to each of a plurality of the past timings;
further calculating a proper job level at each of a plurality of the past timings, by use of the job offer information extracted with regard to each of a plurality of the past timings; and
performing processing for predicting a future job level of the user, based on a current proper job level and a proper job level at each of a plurality of the past timings, and displaying a prediction result.

24. The information providing method according to claim 17, further comprising:
further acquiring past job history information of the user;
further calculating a similarity degree between the past job history information and each of a plurality of pieces of job offer information;
further extracting the job offer information of which the similarity degree regarding the past job history information is equal to or more than a predetermined criterion;
further calculating a past proper job level of the user, by use of the job offer information extracted with regard to the past job history information;
calculating a growth degree of the user, based on a difference between a current proper job level and a past proper job level of the user; and
performing processing for displaying the growth degree.

25. A non-transitory computer-readable medium storing a program that causes a computer to achieve:
a function of acquiring job history information indicating a job history of a user;
a function of calculating a similarity degree between the job history information and each of a plurality of pieces of job offer information;
a function of extracting the job offer information of which the similarity degree is equal to or more than a predetermined criterion;
a function of calculating a proper job level of the user by use of the extracted job offer information; and
a function of performing processing for displaying the calculated proper job level.
